(19) United States
(12) Patent Application Publication
(10) Pub. No.: US 2004/0002369 A1
(43) Pub. Date: Jan. 1, 2004

(54) Method and apparatus for modifying a game based on results of game plays

(76) Inventors: Jay S. Walker, Ridgefield, CT (US); James A. Jorasch, Stamford, CT (US); Russell P. Sammon, San Francisco, CA (US); Magdalena M. Fincham, Norwalk, CT (US)

Correspondence Address: WALKER DIGITAL, FIVE HIGH RIDGE PARK, STAMFORD, CT, 06905, US

(21) Appl. No.: 10/427,823

(22) Filed: May 1, 2003

Related U.S. Application Data
(60) Provisional application No. 60/378,289, filed on May 6, 2002.

(51) Int. Cl. G06F 17/00; G06F 19/00

(52) U.S. Cl. 463/1

(57) ABSTRACT

In accordance with one or more embodiments, a first set of results obtained over a plurality of game plays of a game is evaluated to determine whether the results of the first set of results satisfy one or more predetermined criteria. An example of a predetermined criterion is a desired standard deviation. The results may satisfy the desired standard deviation, for example, if a calculated standard deviation of the results is within a predetermined range of the desired standard deviation. In one or more embodiments, if the results do not satisfy the one or more predetermined criteria, the game is adjusted. The game may be adjusted by, for example, adjusting one or more parameters of the game. In accordance with one or more embodiments, a goal of the adjustment may be to adjust the game such that a second set of results, obtained under the game as defined by the adjusted game parameters, are expected to satisfy the one or more predetermined criteria.

### RELATED APPLICATIONS

This application claims the benefit of commonly-owned, co-pending U.S. Provisional Patent Application Serial No. 60/378,289, filed May 6, 2002, entitled “METHODS AND APPARATUS FOR MANAGING SCORES”. This Application is incorporated by reference herein, in its entirety, for all purposes.

### BACKGROUND OF THE INVENTION

Gaming establishment operators, such as operators of online gaming Web sites and arcades, profit when players play games at their establishments. The operators are thus interested in keeping the players happy and motivated in order to maximize the chances that the players will return in the future to play games and encourage friends and family members to visit the establishments.

Players tend to be happy and motivated when they either achieve good results while playing (e.g., a valuable prize or high score) or at least come close to doing so. For example, a player who does not win a valuable prize or achieve a high score might still be happy and motivated and want to play the game again if he at least comes close to winning a prize or achieving a high score. Conversely, a player that does not come anywhere near to winning a valuable prize or whose score is particularly low (as compared to scores achieved by other players) is likely to be so discouraged as to avoid playing the game again.

Unfortunately, when beginning players (or players of low skill level) play a game, their scores tend to be low and they tend to win few, if any, prizes. This typically results in a feeling of unhappiness, boredom, and/or lack of motivation on the player's part to keep playing the game. Such lack of motivation may be exacerbated by the fact that the same game is typically also being played by more experienced or more skilled players, who are achieving substantially better results. For example, a player that is aware of how his result compares to results achieved by other players is likely to become discouraged and unlikely to keep playing the game if his result is substantially less favorable than the results of most other players.

Players may also become bored and discouraged if they achieve substantially the same result each time they play a game. Players may become similarly bored and discouraged if most players achieve substantially similar results when playing the game, regardless of skill level or experience. Players may consider such a game too predictable and unexciting and thus avoid playing the game.

Because many games tend to be played by a substantial number of inexperienced or low skill players, the loss of discouraged players can lead to substantial revenue decreases for businesses that manage games. What is needed is a system and method for managing a game such that inexperienced and low skill players remain motivated and happy such that they continue playing the game, while minimizing the number of players who become bored or unmotivated due to a lack of variety in results achieved for the game.

### BRIEF DESCRIPTION OF THE FIGURES

FIG. 1 is a graph illustrating a plurality of range bars, each range bar representing a range of scores achieved in a respective game during a particular period of time, consistent with some embodiments of the present invention.

FIG. 2 is a block diagram illustrating an example system according to some embodiments of the present invention.

FIG. 3 is a block diagram illustrating an example of a gaming establishment controller, such as the controller 205 depicted in FIG. 2 and consistent with some embodiments of the present invention.

FIG. 4 is a block diagram illustrating an example of a gaming device, such as a gaming device 210 depicted in FIG. 2 and consistent with some embodiments of the present invention.

FIG. 5 is a table 500 illustrating an example data structure of an example player database 335 as depicted in FIG. 3 and for use in some embodiments of the present invention.

FIG. 6A is a table 600 illustrating an example data structure of an example game play database 340 as depicted in FIGS. 3 and 4 and for use in some embodiments of the present invention.

FIG. 6B is a table 650 illustrating an example data structure of an example record of the game play database 340 as depicted in FIGS. 3 and 4 and for use in some embodiments of the present invention.

FIG. 7A is a table 700 illustrating an example data structure of an example game database 345 as depicted in FIGS. 3 and 4 and for use in some embodiments of the present invention.

FIG. 7B is a table 750 illustrating an example data structure of an example record of an example game database 345 as depicted in FIGS. 3 and 4 and for use in some embodiments of the present invention.

FIG. 7C is a table 770 illustrating an example data structure of an example record of an example game database 345 as depicted in FIGS. 3 and 4 and for use in some embodiments of the present invention.

FIG. 8 is a table 800 illustrating an example data structure of an example available game adjustments database 350 as depicted in FIGS. 3 and 4 and for use in some embodiments of the present invention.

FIG. 9A and FIG. 9B are a flow diagram illustrating an exemplary process 900 for facilitating the maintenance of game results within a predetermined range of a desired standard deviation according to and for use in some embodiments of the present invention.

FIG. 9C is a graph 930 illustrating a range of example game results before an adjustment of a game and a graph 950 illustrating a range of example game results after an adjustment of the game.

FIG. 10A and FIG. 10B are a flow diagram illustrating an exemplary process 1000 for facilitating the maintenance of game results within a predetermined range according to and for use in some embodiments of the present invention.

FIG. 10C is a graph 1030 illustrating a range of example game results before an adjustment of a game and a graph 1050 illustrating a range of example game results after an adjustment of the game.

### DETAILED DESCRIPTION OF SOME EMBODIMENTS OF THE INVENTION

The invention overcomes the above and other drawbacks of the prior art by providing a method for managing the wide disparity in the results of a game that may be due to the wide disparity in experience and skill level of the players playing the game while also maintaining sufficient disparity in the results to keep player interest in the game. The systems and methods of the present invention facilitate adjustment of a game in order to help ensure that a set of results obtained during a plurality of game plays of a game satisfy one or more predetermined criteria (e.g., that a standard deviation of the results is not greater than a maximum predetermined standard deviation and not lower than a minimum predetermined standard deviation).

Applicants have recognized that gaming establishments would benefit from maintaining results of games within a range that is not so wide as to discourage novice or low skill players. Applicants have also recognized that gaming establishments would benefit from maintaining results of games within a range that is not so narrow as to result in bored and unmotivated players. The present invention, in accordance with one or more embodiments, allows a gaming establishment to adjust a game such that results of a game are maintained within a range determined to be desirable by the gaming establishment.

According to one embodiment, the invention provides a method of determining whether a set of results for a game satisfies one or more predetermined criteria and adjusting the game based on this determination. For example, the determination of whether a set of results for a game satisfies one or more predetermined criteria may comprise calculating a variance of the results and determining whether the calculated variance is within a predetermined range of a desired variance. In another example, the determination of whether a set of results for a game satisfies one or more predetermined criteria may comprise calculating a standard deviation of the results and determining whether the calculated standard deviation is within a predetermined range of a desired standard deviation. In yet another example, the determination of whether a set of results for a game satisfies one or more predetermined criteria may comprise determining a lower bound and an upper bound of a desired range and determining whether the results fit within desired range. In one or more embodiments, determining whether a set of results satisfies one or more predetermined criteria may comprise determining whether the results fit within a desired range. This may comprise determining whether a predetermined portion (e.g., ninety percent) of the results fit within the desired range.

Embodiments of the invention may be practiced, for example, by an operator of a Web server that hosts a website, which players may log on to and play games of skill to win prizes. As players play games on the Web site, a computing device may monitor the games played to determine a variance in prizes awarded based on results of the games. If the variance in prizes awarded is too high, this may be discouraging to players, since expert players may win large prizes while novice players win almost nothing. Similarly, if the variance in prizes is too low, players may become bored because there is not enough variation in the prizes awarded. If the computing device determines that the variance in prizes for a game is too high or too low, then it may modify the game to alleviate this problem.

A “result” of a game, as used herein unless expressly stated otherwise, comprises an expression of a player's performance in a game play of a game. For example, a score is a result of a game. A score may comprise, for example, a sum of points awarded to the player for events achieved during the game play. In another example, a prize won by a player during a game play is a result of the game play. In a third example, a value (monetary or non-monetary) of a prize won by a player during a game play is a result of the game play. In a fourth example, a binary indication of whether a player won a prize (e.g., “yes” or “no”) during a game play is a result of the game play. Note that winning a prize “during” a game play, as used herein, includes winning a prize at the conclusion of a game play.

Note that, for purposes of this invention, the term “game” should be distinguished from the term “game play”. A game comprises a set of rules according to which a prize or points may be obtained. For example, Pac Man™ is a game. A game play comprises an attempt to obtain a score or win a prize in accordance with the rules of the game and ends at a designated time (e.g., once the prize is won or a number of “lives” or “rounds” is played without having won the prize).

According to one embodiment, a game may be adjusted by adjustment of one or more parameters of the game. A parameter of a game comprises a rule of the game that has an associated value and affects the result of a game play of the game (e.g., what prize is awarded for a game play of the game). A parameter of a game may be adjusted by adjusting the value associated with the parameter. For example, a game named “Space Battles” may have a variance in results of the game that is too high. Assume that parameters of the game include (i) a number of lives, (ii) spaceship speed, and (iii) meteorite size. The game “Space Battles” may thus be adjusted to reduce the variance in results of the game by adjusting one or more of these parameters. For example, the number of lives may be adjusted from a first value to a second value. For example, increasing the number of lives increases the number of attempts the player has at increasing his score in the game or winning a prize. Accordingly, adjusting this parameter of the number of lives from a first number to a second number that is higher than the first number may result in an adjustment in the variance of results since this adjustment may be particularly effective at increasing the possibility that a novice or low skill player will win a prize or achieve a high score.

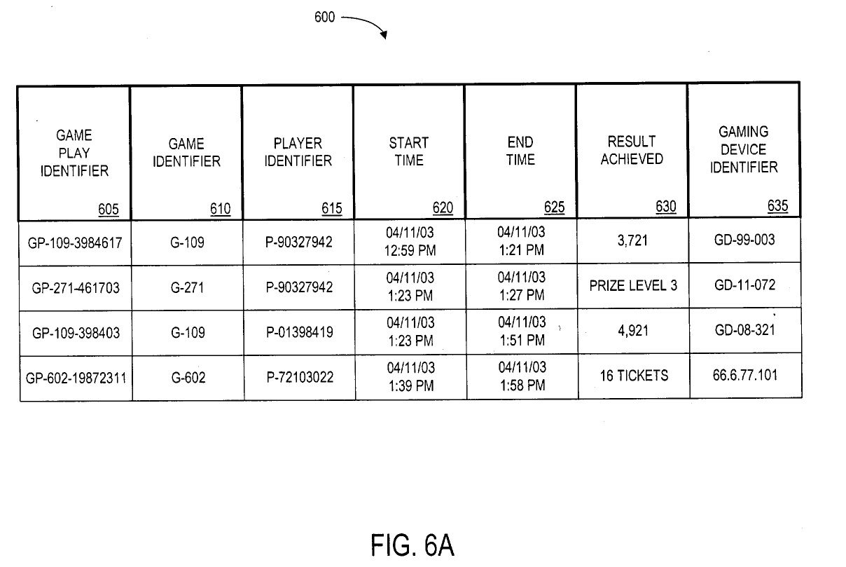

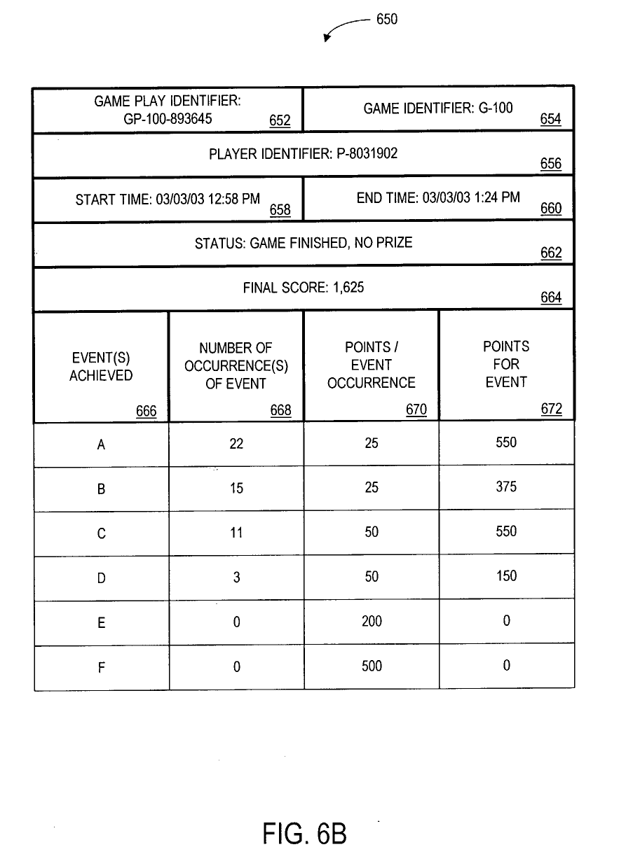

According to one embodiment, a game may be adjusted by adjusting a number of points awarded for the achievement of particular events during a game play of a game. For example, destroying an asteroid and destroying an enemy space ship may each be an event in the game of “Space Battles” for which a number of points are awarded. A score may thus be manipulated by adjusting the number of points awarded for each event. For example, assume that according to the rules of the game it is very easy to destroy an asteroid (e.g., because it is very large and moves very slowly) so even novice or low skill players can achieve this event. Further assume that destroying an enemy space ship is very difficult (e.g., because they move very quickly and have armor). If it was desired to adjust the game in order to raise the scores of the novice players while minimizing any increase in the scores of expert players, one method of doing so may comprise increasing the number of points awarded for destroying an asteroid while maintaining or decreasing the number of points awarded for destroying an enemy space ship. A more detailed description of such an exemplary method is described below with reference to FIG. 6B.

One embodiment of the present invention involves determining which parameter of a game is to be adjusted (and the new value for the game parameter), based on the goal of the adjustment. For example, if it is determined that a mean of results is satisfactory but a standard deviation of results is too large, a first set of parameters of the game may be selected for adjustment. However, if it is determined that the mean of results is not satisfactory (e.g., it is too low) and the standard deviation of results is too large, a second set of parameters of the game may be selected for adjustment. Note that one or more parameters included in the first set may also be included in the second set.

In one or more embodiments, the success of an adjustment of a game may be verified after it is executed. For example, results achieved by players playing the adjusted game may be tracked and evaluated to determine whether they fit into a desired range. If the results achieved in the adjusted game still do not fit into the desired range, a further adjustment of the game may be executed.

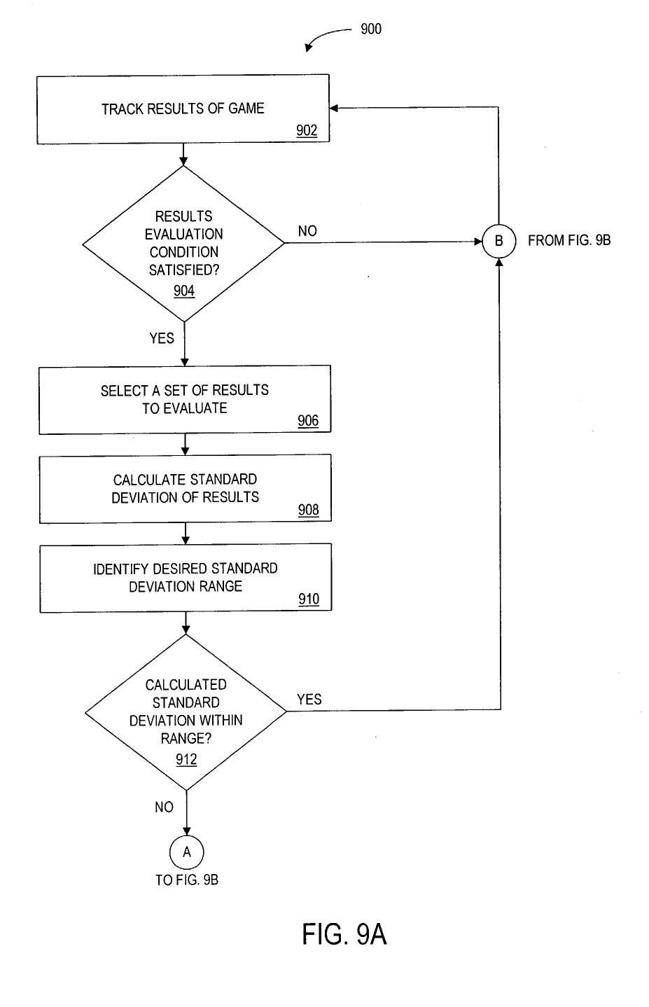

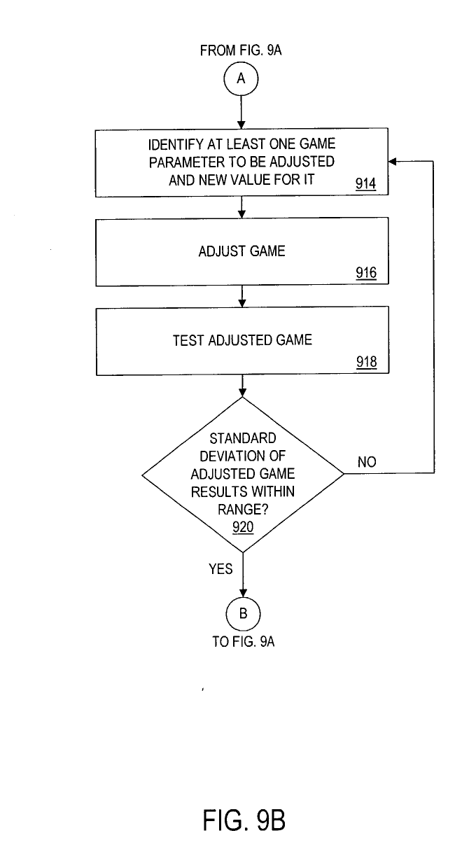

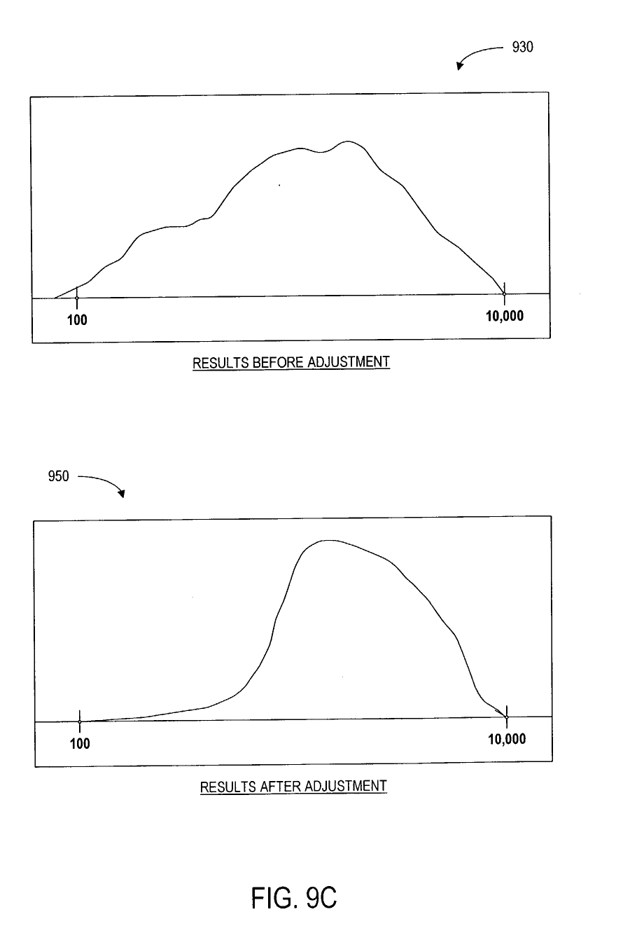

In some embodiments, a game is adjusted in order to maintain a standard deviation of results within a predetermined range. For example, results obtained for the game are determined and a standard deviation of the results is calculated. The calculated standard deviation is compared to a range of desired standard deviations. If the calculated standard deviation is not within the range, the game is adjusted such that expected results for future game plays of the game will have a standard deviation within the range. An illustration of this method is described below with respect to FIGS. 9A and 9B.

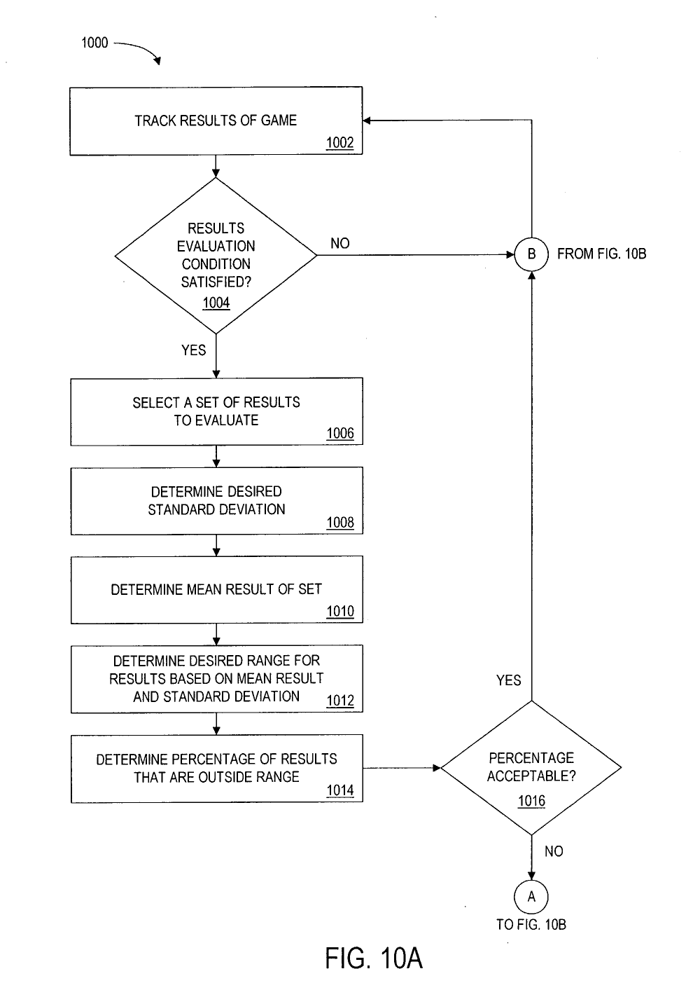

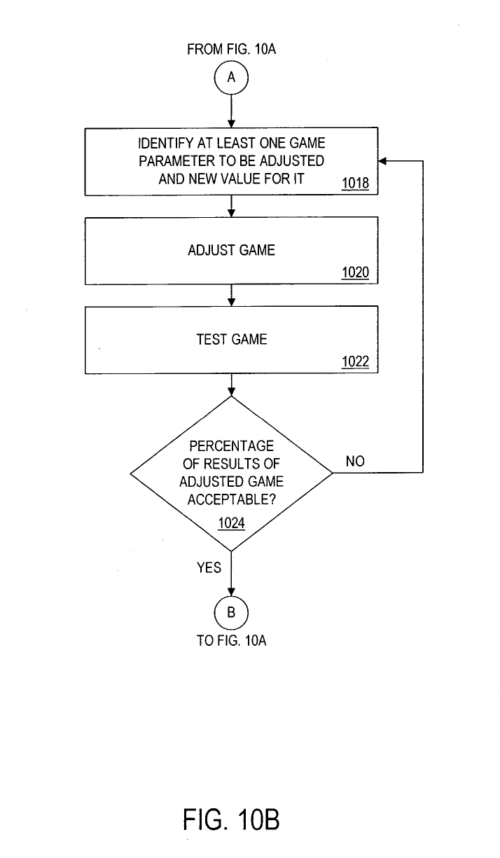

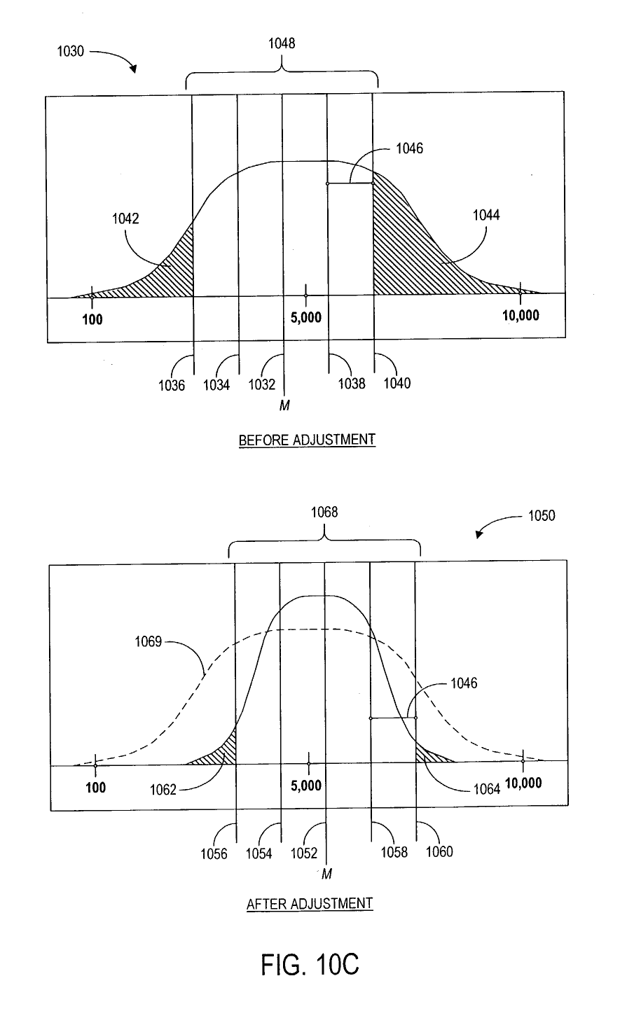

In some embodiments, a game is adjusted in order to maintain results of the game within a desired range of a mean of the results. For example, a mean of a set of results obtained for a game is determined. A desired standard deviation is also determined. A desired range of results is then determined, where the lower bound of the range is the mean minus the desired standard deviation (or minus a product of a predetermined number and the desired standard deviation) and the upper bound of the range is the mean plus the desired standard deviation (or plus a product of a predetermined number and the desired standard deviation). The portion of the set of results that do not fit within the desired range is determined and the game is adjusted if the portion is greater than a predetermined portion. The game is adjusted such that the predetermined portion of expected results for future game plays of the game will probably fit into the desired range, which may be determined anew based on the future results once they are obtained. An illustration of this method is described below with respect to FIGS. 10A and 10B.

In one embodiment, a game may be played in accordance with a first set of values, each value respectively corresponding to a parameter of the game, if the player is a first player and played in accordance with a second set of values if the player is a second player. For example, a skill level of a player may be a factor that determines which set of values the game is to be played with. In another example, an identity of a player may determine which set of values the game is to be played with.

Note that when a game is adjusted, it is adjusted such that expected results to be achieved by players in future game plays will satisfy the one or more predetermined criteria. The results that were achieved prior to the adjustment and evaluated in order to determine whether the game should be adjusted are not affected by the adjustment.

Note further that the difficulty of a game is not necessarily affected by the adjustment of the game. The difficulty of the game may remain substantially unaltered. For example, in one or more embodiments a game is adjusted by adjusting the number of points awarded for achievement of one or more events in a game play of the game (e.g., the number of points for eating a strawberry in PacMan™ may be adjusted from fifty points to one hundred points), in which case the difficulty of the game remains unaffected.

A gaming establishment benefits from the invention by realizing increased revenue, since players are less likely to become discouraged and unmotivated in a gaming establishment practicing aspects of the present invention. Players that do not become discouraged and unmotivated are more likely to return to the gaming establishment and continue playing games, thus producing increased revenue for the gaming establishment.

An entity that provides products or services to the gaming establishment, which products and services players may purchase using points, tickets or other currency earned while playing games at the gaming establishment, may also benefit from the present invention. If a game is adjusted such that more players earn more points or tickets then more products and services will be purchased from the entity. Also, if a game is adjusted such that more players return or visit the gaming establishment, the entity benefits by having a larger clientele available to purchase the products and services.

With these and other advantages and features of the invention that will become hereinafter apparent, the nature of the invention may be more clearly understood by reference to the following detailed description of the invention, the appended claims and to the several drawings included herein.

In the following description, reference is made to the accompanying figures that form a part hereof, and in which is shown, by way of illustration, specific embodiments in which the invention may be practiced. It should be noted that, with reference to the numbering of elements of the figures, the left most digit(s) of a reference numeral identifies the figure in which the reference numeral first appears. The embodiments described herein are described in sufficient detail to enable those skilled in the art to practice the invention, and it is to be understood that other embodiments may be utilized and that structural, logical, software, and electrical changes may be made without departing from the scope of the present invention. The following description is, therefore, not to be taken in a limited sense.

It should also be noted that, as used herein, the terms “an embodiment”, “embodiment”, “embodiments”, “the embodiment”, “the embodiments” “one or more embodiments”, “some embodiments”, and “one embodiment” mean “one or more embodiments” unless expressly specified otherwise. Further, although particular features of the present invention may be described with reference to one or more particular embodiments or figures, it should be understood that such features are not limited to usage in the one or more particular embodiments or figures with reference to which they are described.

Embodiments of the present invention will first be introduced by means of a hi-lo graph that illustrates some manipulations of results that may be realized via uses of some embodiments of the present invention. The system infrastructure will then be described with reference to block diagrams of exemplary systems and devices that may be utilized by an entity practicing the present invention. Exemplary data structures illustrating tables that may be used when practicing embodiments of the present invention will then be described, along with corresponding flowcharts that illustrate exemplary processes that utilize the exemplary tables.

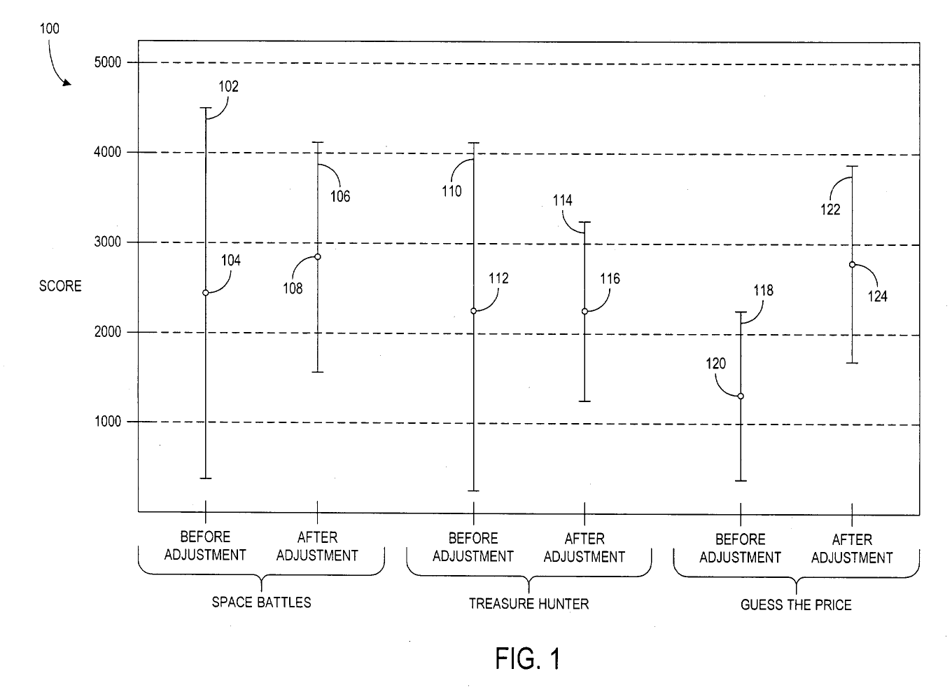

Referring now to FIG. 1, a hi-lo graph 100 illustrates a plurality of range bars, including range bar 102, range bar 106, range bar 110, range bar 114, range bar 118, and range bar 122. Each range bar represents a range of a plurality of scores achieved, each score comprising a score achieved during a game play of a particular game during a predetermined period of time (e.g., within a particular week or within a period of time defined by the most recent one thousand game plays of the game). The maximum of a range bar represents the maximum relevant score of the particular game during the period of time. The minimum of a range bar represents the minimum relevant score of the particular game during the period of time. A score may be relevant, for example, if it is included in a set of scores selected for evaluation and thus inclusion in the range bar. For example, in some embodiments all of the scores achieved for respective game plays of a particular game during the predetermined period of time may be relevant and thus represented in the range bar. In other embodiments, a subset of scores achieved for respective game plays of a particular game may be selected as relevant (e.g., outlier or duplicate scores may be excluded).

The median score of each range of scores is also indicated. For example, median score 104 of range bar 102 is approximately “2300 points”, median score 108 of range bar 106 is approximately “2950 points”, median score 112 of range bar 110 is approximately “2270 points”, median score 116 of range bar 114 is approximately “2270 points”, median score 120 of range bar 118 is approximately “1270 points”, and median score 124 of range bar 122 is approximately “2900 points”.

Graph 100 illustrates a pair of range bars for each of three games, the games being named “Space Battles”, “Treasure Hunter”, and “Guess the Price”, respectively. The range bar 102 and the range bar 106 each respectively represents a range of scores for the game named “Space Battles”. The range bar 110 and the range bar 114 each respectively represents a range of scores for the game named “Treasure Hunter”. The range bar 118 and the range bar 122 each respectively represents a range of scores for the game named “Guess the Price”.

For each pair of range bars, the left-most range bar represents the range of scores before an adjustment of the corresponding game was executed. The right-most range bar represents the range of scores for the corresponding game after the adjustment of the game was executed. As can be seen from a comparison of each pair of graphs, the range of scores can be manipulated in a variety of manners by adjusting the game.

For example, referring now to the range bar 102 and the range bar 106, each representing scores for the game “Space Battles”, it can be seen that the range of scores after an adjustment of the game has been executed is more compressed than the range of scores before the adjustment. The range bar 102, representing the range of scores before an adjustment of the game “Space Battles” is bounded by a high score of approximately “4550 points” and a low score of approximately “310 points”. Thus the range of scores before an adjustment of the game is approximately “4240 points” (4550−310=4240). The range bar 106, representing the range of scores after an adjustment of the game “Space Battles” is bounded by a high score of approximately “4125 points” and a low score of approximately “1700 points”. Thus the range of scores after the adjustment of the game is approximately “2425 points” (4125−1700=2425).

Note that, in addition to compressing (or, in some embodiments, expanding) the range into which scores of a game fall, the range may be manipulated in other manners as well. For example, the game may be adjusted such that the highest score and/or the lowest after the adjustment is higher or lower (depending on the needs or desires of the gaming establishment), than the highest score and/or the lowest score before the adjustment. Range bar 106 and range bar 102 together illustrate such an effect, since the hi and lo of range bar 106 are each respectively lower than the hi and lo of range bar 102.

The mean and/or median of a range of future scores may also be manipulated by adjusting a game. In other words, a game may be adjusted with the goal of raising or lowering the mean or median of a range of future scores from the mean or median of past scores. Range bars 102 and 106 together also illustrate such an effect. The median 104 of range bar 102 (which represents the range of scores before adjustment of the game) is approximately “2300 points” while the median 108 of range bar 106 is approximately “2950 points”. An operator of a gaming establishment may desire to, for example, raise a median or mean score of a game in order to further motivate players by enabling more players to achieve a score that corresponds to a prize (e.g., a more valuable prize) or that is closer to a score that corresponds to a prize.

System

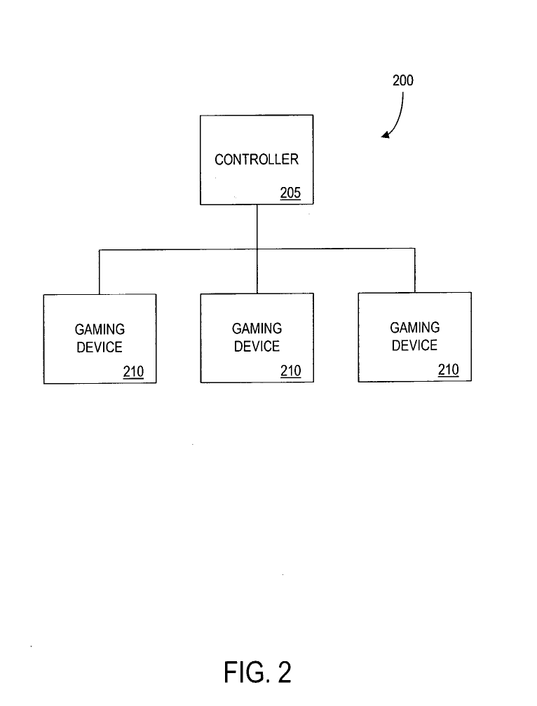

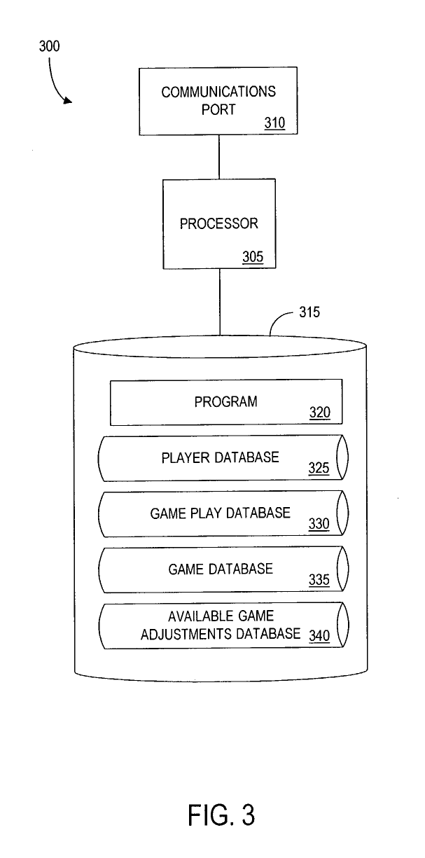

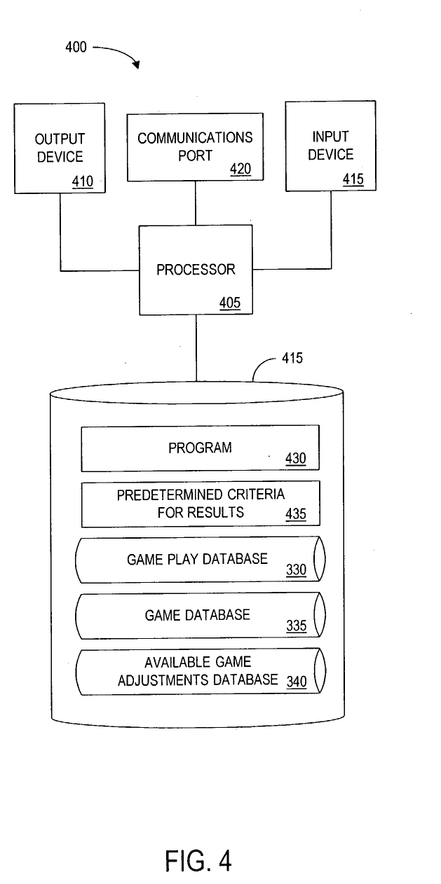

Referring now to FIG. 2, an example embodiment of a system 200 that may be used to implement one or more embodiments of the present invention is depicted by means of a block diagram. The system 200, according to some embodiments, may include a controller 205 (an example of which is depicted in FIG. 3) in one or two-way communication with a plurality of gaming devices 210 (an example of which is depicted in FIG. 4) via a network such as, for example, the Internet or via another communications link. The controller 205 may comprise a server of a gaming establishment, such as an online gaming Web site or a brick and mortar arcade. Although not pictured, other devices besides gaming devices 210 may be connected to the controller 205. Likewise, servers of other gaming establishments and other entities may be in direct or indirect communication with the controller 205.

In accordance with one or more embodiments, the controller 205 may function under the control of a gaming establishment, a gaming establishment operator, a prize distributor, a merchant, or other entity that may also control use of the gaming devices 210. In some embodiments, the controller 205 may also serve other functions besides those particular to the invention. For example, the controller 205 may track payment information or otherwise facilitate payment for games and/or monitor operational integrity of the gaming devices 210.

The controller 205 may, in one or more embodiments, function as a “Web server” that presents and/or generates Web pages or other documents typically stored on network-connected computers accessible (e.g., via an intranet, via the World Wide Web) using protocols such as, e.g., the hyper-text transfer protocol (HTTP). Such documents typically include one or more hyper-text markup language (HTML) files, associated graphics, and script files. A Web server allows communication with various devices in a manner known in the art. In some embodiments, one or more of the gaming devices 210 may use a Web browser, such as NAVIGATOR® published by NETSCAPE®, for accessing HTML forms generated or maintained by or on behalf of the controller 205.

The controller 205 may communicate with the gaming devices 210 directly or indirectly, via a wired or wireless medium such as the Internet, LAN, WAN or Ethernet, Token Ring, or via any appropriate communications means or combination of communications means. Each of the gaming devices 210 may comprise computers, such as those based on the Intel®t Pentium® processor, that are adapted to communicate with the controller 205. Any number and type of gaming devices 210 may be in communication with the controller 205.

Communication between the gaming devices 210 and the controller 205, and among the gaming devices 210, may be direct or indirect, such as over the Internet through a Web site maintained by controller 205 on a remote server or over an on-line data network including commercial on-line service providers, bulletin board systems and the like. In yet other embodiments, the gaming devices 210 may communicate with one another and/or controller 205 over RF, cable TV, satellite links and the like.

Some, but not all, possible communication networks that may comprise network 215 or be otherwise part of system 200 include: a local area network (LAN), a wide area network (WAN), the Internet, a telephone line, a cable line, a radio channel, an optical communications line, a satellite communications link. Possible communications protocols that may be part of system 200 include: Ethernet (or IEEE 802.3), SAP, ATP, Bluetooth∞, and TCP/IP. Communication may be encrypted to ensure privacy and prevent fraud in any of a variety of ways well known in the art.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

In an embodiment, the controller 205 may not be necessary and/or preferred. For example, the present invention may, in one or more embodiments, be practiced on a stand-alone gaming device 210 and/or a gaming device 210 in communication only with one or more other gaming devices 210. In such an embodiment, any functions described as performed by the controller 205 or data described as stored on the controller 205 may instead be performed by or stored on one or more gaming devices 210.

FIG. 2 depicts only an exemplary embodiment of the invention. Other arrangements of devices to perform various methods specified herein will be readily appreciated by those of skill in the art.

Devices

Controller

Referring now to FIG. 3, illustrated therein is a block diagram of an embodiment 300 of controller 205 (FIG. 2). The controller 300 may be implemented as a system controller, a dedicated hardware circuit, an appropriately programmed general-purpose computer, or any other equivalent electronic, mechanical or electromechanical device. The controller 300 may comprise, for example, a server computer operable to communicate with one or more client devices, such as gaming devices 210. The controller 300 is operative to manage the system 200 and execute the methods of the present invention.

In operation, the controller 300 may function under the control of a gaming establishment operator or other entity that may also control use of the gaming devices 210. For example, the controller 300 may be a server of a gaming Web site. In some embodiments, the controller 300 may comprise more than one computer operating together.

The controller 300 comprises a processor 305, such as one or more Intel® Pentium® processors. The processor 305 is in communication with a communications port 310 (e.g., for communicating with one or more other devices) and a memory 315. The memory 315 may comprise an appropriate combination of magnetic, optical and/or semiconductor memory, and may include, for example, Random Access Memory (RAM), Read-Only Memory (ROM), a compact disc and/or a hard disk. The processor 305 and the memory 310 may each be, for example: (i) located entirely within a single computer or other device; or (ii) connected to each other by a remote communication medium, such as a serial port cable, telephone line or radio frequency transceiver. In one embodiment, the controller 300 may comprise one or more devices that are connected to a remote server computer for maintaining databases.

The memory 315 stores a program 320 for controlling the processor 305. The processor 305 performs instructions of the program 320, and thereby operates in accordance with the present invention, and particularly in accordance with the methods described in detail herein. The program 320 may be stored in a compressed, uncompiled and/or encrypted format. The program 320 furthermore includes program elements that may be necessary, such as an operating system, a database management system and “device drivers” for allowing the processor 305 to interface with computer peripheral devices. Appropriate program elements are known to those skilled in the art, and need not be described in detail herein.

According to an embodiment, the instructions of the program 320 may be read into a main memory from another computer-readable medium, such from a ROM to RAM. Execution of sequences of the instructions in program 320 causes processor 305 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The memory 315 also stores a plurality of databases, including a player database 325, a game play database 330, a game database 335, and an available game adjustments database 340. At least one example embodiment of each of theses databases, and a use therefore, is described in detail below. Note that, although these databases are described as being stored in a controller 300, in other embodiments of the present invention some or all of these databases (or some or all of the data stores therein) may be partially or wholly stored in another device, such as one or more of the gaming devices 210 (in addition to or in lieu of being stored in controller). In one or more embodiments, there may be duplication of data that is stored in a database of controller and a database of a gaming device 210.

Gaming Device

Referring now to FIG. 4, illustrated therein is a block diagram of an embodiment 400 of a gaming device. The gaming device 400 may be implemented as a system controller, a dedicated hardware circuit, an appropriately programmed general-purpose computer, or any other equivalent electronic, mechanical or electromechanical device. The gaming device 400 may comprise, for example, a personal computer (e.g., which communicates with an online gaming Web site), a telephone (e.g., to communicate with an automated sports book that provides gaming services), a portable handheld gaming device (e.g., a personal digital assistant or Nintendo GameBoy), or a gaming terminal in a brick-and-mortar gaming establishment (e.g., an arcade game console). The gaming device 400 may comprise any or all of the gaming devices 210 of system 200 (FIG. 2).

The gaming device 400 comprises a processor 405, such as one or more Intel® Pentium® processors. The processor 405 is in communication with an output device 410, an input device 415, a communication port 420, and a memory 425.

The memory 425 may comprise an appropriate combination of magnetic, optical and/or semiconductor memory, and may include, for example, Random Access Memory (RAM), Read-Only Memory (ROM), a compact disc and/or a hard disk. The memory 425 may comprise or include any type of computer-readable medium. The processor 405 and the memory 425 may each be, for example: (i) located entirely within a single computer or other device; or (ii) connected to each other by a remote communication medium, such as a serial port cable, telephone line or radio frequency transceiver. In one embodiment, the gaming device 400 may comprise one or more devices that are connected to a remote server computer for maintaining databases.

The memory 425 stores a program 430 for controlling the processor 405. The processor 405 performs instructions of the program 430, and thereby operates in accordance with the present invention, and particularly in accordance with the methods described in detail herein. The program 430 may be stored in a compressed, uncompiled and/or encrypted format. The program 430 furthermore includes program elements that may be necessary, such as an operating system, a database management system and “device drivers” for allowing the processor 405 to interface with computer peripheral devices. Appropriate program elements are known to those skilled in the art, and need not be described in detail herein.

The term “computer-readable medium” as used herein refers to any medium that participates in providing instructions to processor 405 (or any other processor of a device described herein) for execution. Such a medium may take many forms, including but not limited to, non-volatile media, volatile media, and transmission media. Non-volatile media include, for example, optical or magnetic disks, such as memory 425. Volatile media include dynamic random access memory (DRAM), which typically constitutes the main memory. Transmission media include coaxial cables, copper wire and fiber optics, including the wires that comprise a system bus coupled to the processor 405. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying one or more sequences of one or more instructions to processor 405 (or any other processor of a device described herein) for execution. For example, the instructions may initially be borne on a magnetic disk of a remote computer. The remote computer can load the instructions into its dynamic memory and send the instructions over a telephone line using a modem. A modem local to a gaming device 400 (or, e.g., a controller 205) can receive the data on the telephone line and use an infrared transmitter to convert the data to an infrared signal. An infrared detector can receive the data carried in the infrared signal and place the data on a system bus for processor 405. The system bus carries the data to main memory, from which processor 405 retrieves and executes the instructions. The instructions received by main memory may optionally be stored in memory 425 either before or after execution by processor 405. In addition, instructions may be received via communications port 420 as electrical, electromagnetic or optical signals, which are exemplary forms of carrier waves that carry data streams representing various types of information. Thus, the gaming device 400 may obtain instructions in the form of a carrier wave.

According to an embodiment, the instructions of the program 430 may be read into a main memory from another computer-readable medium, such from a ROM to RAM. Execution of sequences of the instructions in program 430 causes processor 405 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The program 430 may also store instructions on conducting one or more games on the gaming device 400. For example, in embodiments where the gaming device 400 comprises a game console in an arcade that is programmed to conduct a particular game, the program 430 may include the code for conducting the particular game. Alternatively, the code and instructions for conducting the game may be separate from the program 430 for controlling the processor 405 in accordance with embodiments of the present invention.

The memory 425 also stores a predetermined criteria for results 435. The predetermined criteria for results may comprise information indicative of one or more criteria that a range of results achieved over a plurality of respective game plays of a game is to satisfy. Gaming device 400 may use such information to determine whether a game needs to be adjusted by determining whether a range of results for a game satisfies the one or more predetermined criteria. Note that a different one or more criteria may be applied to different ranges of results. For example, a first range of results achieved for a first difficulty level of a game (and/or achieved by players of a first skill level) may be compared to a first one or more predetermined criteria while a second range of results achieved for a second difficulty level of a game (and/or achieved by players of a second skill level) may be compared to a second one or more criteria. If it is determined that a range of results does not satisfy the one or more applicable predetermined criteria, the game may be adjusted such that a range of results of future game plays is expected to satisfy the one or more applicable predetermined criteria.

The predetermined criteria for results 435 may be stored in different formats. For example, a number comprising a desired standard deviation may be stored as a predetermined criterion. In such an example the gaming device 400 (or another device) may determine a mean or median result of a set of results achieved for a game and determine whether the remainder of the set of results fit into a range defined by a lower bound that is the mean or median result minus the standard deviation and the upper bound is the mean or median result plus the standard deviation.

In another example, storing the predetermined criteria for results 435 may comprise storing a particular number to be multiplied by a particular desired standard deviation, along with a number comprising the desired standard deviation, for use in determining an upper and lower bound of a desired range into which results should fit. Thus, for example, a desired range may be defined by (i) a lower bound that is mean or median less the product of the desired standard deviation and the number, and (ii) an upper bound that is the mean or median plus the product of the desired standard deviation and the number.

In yet another example, the predetermined criteria for results 435 may comprise a first value defining a lower bound of a desired range and a second value defining an upper bound of the range.

In yet another example, the predetermined criteria for results 435 may comprise a desired mean or median game result for use in determining a desired range of results. For example, the following information may be stored and used to determine a desired range into which game results should fit: (i) a desired mean, (ii) a desired standard deviation, and (iii) a stored number by which the desired standard deviation is to be multiplied.

In one or more embodiments, gaming device 400 may access the predetermined criteria for results 435 from another device rather than storing it locally. For example, gaming device 400 may obtain such information from controller 300.

Note that each game available on a gaming device of system 200 may be associated with one or more predetermined criteria that a range of results for the game are to satisfy or else the game is to be adjusted. The one or more predetermined criteria may be a first predetermined criteria for a first game and a second one or more predetermined criteria for a second game. The one or more predetermined criteria for a particular game may be specified by the designer of the game, an operator of the gaming establishment in which the game is played, a provider of prizes for the gaming establishment, another entity, or a combination thereof. Further, the one or more predetermined criteria for a game may be changed by any of the afore-mentioned entities. For example, an operator of a gaming establishment may access the predetermined criteria for results 435 as stored in a gaming device 210 and/or controller 205 and implement a change as desired (e.g., the operator may change a desired standard deviation from a first standard deviation to a second standard deviation).

The memory 425 also stores a plurality of databases, including a game play database 330, a game database 335, and an available game adjustments database 340. Note that the databases 330, 335, and 340 may be the same databases as described with respect to the controller 300 (FIG. 3). However, in embodiments where the databases 330, 335, and 340 are stored in the gaming device 400, they may contain data relevant only to the games conducted on the gaming device 400 in which they are stored. In other embodiments, the databases 330, 335, and 340 may comprise a different data structure, store different data, and/or be used for different functions than the databases of server 300.

As described above, the processor 405 is also operable to communicate with an output device 410. Output device 410 may be operable to output information and/or tangible items. An output of the output device 410 may be provided to, for example, a player, an operator of a gaming establishment, or another device (e.g., controller 205, another gaming device 210, or another device). Output device 410 may be a component of gaming device 400. The output device 410 may be utilized, for example, for outputting information related to a game play played on the gaming device, such as animations associated with the game play and/or results of the game play (e.g., the score achieved for the game play and/or a prize the player playing the game play has qualified for). The output device may comprise, for example, a cathode ray tube (CRT) monitor, liquid crystal display (LCD) screen, or light emitting diode (LED) screen. Other examples of an output device 410 include: an audio speaker, an infra-red transmitter, a radio transmitter, an electric motor, a printer, a coupon or product dispenser, an infra-red port (e.g., for communicating with a second gaming device or a portable device of a player), a Braille computer monitor, and a coin or bill dispenser.

In one or more embodiments, a gaming device may comprise more than one output device. For example, a gaming device may comprise an LCD display for displaying animations of a game, an audio speaker for outputting sound effects during a game play of the game, and an LED screen for displaying a score achieved during a game play of the game.

As described above, the processor 405 is also in communication with an input device 415. Input device 415 may be a device that is capable of receiving an input (e.g., from a player or another device). Input device 415 may be a component of gaming device 400. Input device 415 may communicate with or be part of another device (e.g. a server, a gaming device, etc.). Some examples of an input device 415 include: a bar-code scanner, a magnetic stripe reader, a computer keyboard or keypad, a button, a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from a second gaming device or a another device such as a smart card or PDA of a player), and a weight scale.

In some embodiments, the gaming device 400 may comprise components in addition to those depicted in FIG. 4. For example, in embodiments where payment is received and/or dispensed by gaming device 400, the processor 405 may also be in communication with a payment system (not shown). The payment system may be a component of gaming device 400. The payment system may comprise a device capable of accepting payment from a player (e.g., a bet or initiation of a balance) and/or providing payment to a player (e.g., a payout). Payment is not limited to money, but may also include other types of consideration, including products, services, and alternate currencies.

Exemplary methods of accepting payment by a payment system of gaming device 400 include (i) receiving hard currency (i.e., coins or bills), and accordingly the payment system may comprise a coin or bill acceptor; (ii) receiving an alternate currency (e.g., a paper cashless gaming voucher, a coupon, a non-negotiable token), and accordingly the payment system may comprise a bar code reader or other sensing means; (iii) receiving a payment identifier (e.g., a credit card number, a debit card number, a player tracking card number) and debiting the account identified by the payment identifier; and (iv) determining that a player has performed a value-added activity.

In one or more embodiments, the gaming device 400 may be operable to output a benefit to a player of the gaming device. In such embodiments, the processor 405 may also be operable to communicate with a benefit output device (not shown). The benefit output device may be a component of gaming device 400. The benefit output device may comprise one or more devices for outputting a benefit to a player of the gaming device. For example, in one embodiment the gaming device 400 may provide coins and/or tokens as a benefit. In another example, the gaming device 400 may provide a receipt or other document on which there is printed an indication of a benefit (e.g., a cashless gaming receipt that has printed thereon a monetary value, which is redeemable for cash in the amount of the monetary value). In yet another example, the gaming device 400 may provide electronic credits as a benefit (which, e.g., may be subsequently converted to coins and/or tokens and dispensed from a hopper into a coin tray). In yet another example, the gaming device 400 may credit a monetary amount to a financial account associated with a player as a benefit provided to a player. The financial account may be, for example, a credit card account, a debit account, a charge account, a checking account, or a casino account. In such an embodiment the benefit output device may comprise a device for communicating with a server on which the financial account is maintained.

Note that, in one or more embodiments, a player may operate a plurality of gaming devices. For example, a player may simultaneously play two side-by-side gaming devices or a player may play one gaming device and then continue his gaming session at another gaming device.

In one or more embodiments, a player may remotely operate a gaming device, possibly by using a telephone, PDA or other device (i) to transmit commands (directly or indirectly) to the gaming device, such as wager amounts and commands to select certain cards; and/or (ii) to receive output (directly or indirectly) from the gaming device.

The gaming device 400 may allow a player to play a game of skill, a game of chance, or a game that combines elements of skill and chance. In embodiments where the gaming device 400 allows the player to play games of chance, the gaming device 400 may further be operable to communicate with a random number generator (not shown), which may be a component of gaming device 400.

Databases

The following is a detailed description of exemplary tabular representations of various databases that may be utilized in the present invention. Note that, although the example embodiments depicted in FIG. 2 and FIG. 3, respectively, include particular databases, other database arrangements may be used which would still be in keeping with the spirit and scope of the present invention. In other words, the present invention could be implemented using any number of different database files or data structures, as opposed to the particular ones indicated in FIG. 2 and FIG. 3. Further, the individual database files could be stored on different servers (e.g. located on different storage devices in different geographic locations, such as on a third-party server). Likewise, the programs 320, 430 could also be located remotely from the memories 315, 425 and/or on another server. As indicated above, the programs 320, 430 may include instructions for retrieving, manipulating, and storing data in the databases 325, 330, 335, 340, as may be useful in performing the methods of the invention as will be further described below.

Example embodiments of the databases described as being stored in server 300 and/or gaming device 400 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though four separate databases are illustrated, the invention could be practiced effectively using one, two, three, five, or more functionally equivalent databases. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention.

Player Database

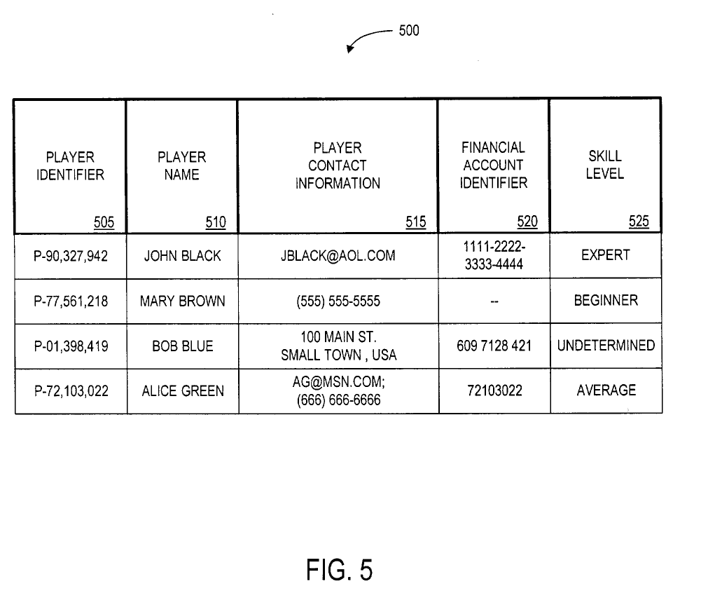

Referring now to FIG. 5, an exemplary tabular representation 500 illustrates an embodiment of a player database 325. The tabular representation 500 of the player database 325 includes a number of example records or entries, each indicating a player registered with a gaming establishment. Those skilled in the art will understand that the player database may include any number of entries. The tabular representation 500 also defines fields for each of the entries or records. The fields specify: (i) a player identifier 505; (ii) a player name 510; (iii) player contact information 515; (iv) a financial account identifier 520 (e.g., to which a payment associated with game play may be charged or credited to); and (v) a skill level 525.

Controller 205 or a gaming device 210 may utilize a player database such as that embodied in tabular representation 500 when processing information associated with a player or interacting with a player. For example, a player database may be utilized to determine how to address a player (e.g., based on the name of the player) in messages directed to the player, determine what financial account to credit with a prize won by a player, and/or to determine a skill level of a player. For example, in one or more embodiments a game may be adjusted for a player based on the skill level of the player in order to ensure that a result obtained by the player in a future game play played by the player fits within a predetermined range.

As will be readily understood, a variety of different types of player identifiers are possible. According to one embodiment, a player identifier may be any information sufficient to identify a player. For example, a player identifier may include an indication of one or more of the following: (i) a player's name (e.g., first name, last name); (ii) a player's home address; (iii) a telephone number of the player; (iv) a player tracking card number; (v) a player's hotel room number (e.g., if a player is staying at a hotel that is associated with a casino); (vi) a player's email or other telecommunication address; (vii) a payment identifier or account identifier that identifies a financial account of a player (e.g., a credit card number, a debit card number, a financial account number); or (viii) an identifier that identifies another type of account associated with a player (e.g., a frequent shopper or frequent gamer account). Accordingly, information stored in other fields of tabular representation 500 may, in one or more embodiments, be utilized as a player identifier.

According to one or more embodiments, a gaming device 210 and/or a controller 205 may receive an indication of a player identifier. The gaming device 210 and/or the controller 205 may be able to access information associated with the player (e.g., the player's name, skill level of the player, etc.) based on the player identifier (e.g., by accessing a corresponding entry in player database 325). Examples of how an indication of a player identifier may be received include, without limitation: (i) a player inserts his player tracking card into a gaming device; (ii) a player uses a numeric keypad to type in his home telephone number; (iii) a player uses a touch screen to type in his username and a password; (iv) a player uses a biometric input device to identify himself (e.g., using a fingerprint scanner); (v) a player indicates a player identifier using an input device on a game machine; (vi) a gaming device transmits a player identifier to a controller (or vice versa); and (vii) a gaming device transmits an indication of a player identifier to another gaming device.

Note that, although a single skill level is shown as being associated with a single player, in one or more embodiments multiple skill levels may be associated with a single player. For example, a player may be of a certain skill level in one game but of another skill level in another game. In another example, a player may be of a certain skill level when playing a first difficulty level of a game but of another skill level when playing a second difficulty level of a game. Accordingly, in one or more embodiments, a skill level may be particular to a game and the skill level field 525 may indicate more than one skill level for a player.

Note further that information other than the categories depicted in FIG. 5 may be stored in the skill level field as an indication of a player's level of skill. For example, an average score or an average value of a prize obtained by the player (e.g., in a particular game) may be stored as an indication of the player's level of skill in that game. In another example, a numerical value (e.g., “3”) representing a level of skill in a predetermined hierarchy of skill levels may be stored.

A record may be opened in the player database when a player first registers with a gaming establishment (e.g, as a member or frequent player of the gaming establishment). A record may also be opened at another appropriate point, such as when the gaming establishment first obtains information about a player that allows the establishment to identify the player (e.g., a credit card number or a username/password combination).

In one or more embodiments, a game may be played according to a first set of game parameter values for players of a first skill level and according to a second set of game parameter values for players of a second skill level. In such embodiments, the player database may be accessed by controller 205 or gaming device 210 when a player first initiates a game to determine the skill level of the player. For example, the player may be requested to provide a player identifier when first initiating a game. The player identifier may be used to access the player's record in the player database. Once the skill level of the player is determined, the game parameter values for the player's game plays may be set or selected (e.g., the respective value corresponding to each game parameter affected by the skill level of the player) based on the skill level. For example, the speed of meteorites in the game named “Space Battles” may be set to a low speed (thus making it easier to destroy) if the player is determined to be a novice or low skill player but set to a relatively higher speed if the player is determined to be an expert player. Such a method exemplifies another manner in which results of a game may be maintained within a desired range.

Note that game parameter values may be stored in a database and retrieved as needed by the gaming device. Alternatively, the gaming device 210 or controller 205 may calculate an appropriate value for a game parameter as necessary.

Not all of the fields depicted in FIG. 5 are required, and various substitutions, deletions and other changes to the tabular representation will be readily apparent to those of ordinary skill in the art.

Game Play Database

A game play database 330 stores information about individual game plays conducted on gaming devices of system 200. The game play database 330 may be used, for example, to track results of game plays for use in determining whether a range of results for a particular game satisfy one or more predetermined criteria.

Referring now to FIG. 6A, an exemplary tabular representation 600 illustrates an embodiment of a game play database 330. The tabular representation 600 of the game play database 330 includes a number of example records or entries, each indicating a game play conducted on a gaming device of system 200. Those skilled in the art will understand that the game play database may include any number of entries. The tabular representation 600 also defines fields for each of the entries or records. The fields specify: (i) a game play identifier 605 that uniquely identifies a game play; (ii) a game identifier 610 that identifies the game that the game play corresponds to; (iii) a player identifier 615 that identifies the player who participated in the game play of a given record; (iv) a start time 620 that indicates the time at which the game play of a given record began; (v) an end time 625 that indicates the time at which the game play of a given record ended; (vi) a result achieved 630 that indicates a result achieved during the game play (e.g., the final score or a prize won) indicated by the record; and (vii) a gaming device identifier 635 that identifies the gaming device on which the game play of a given record was conducted. Note that the gaming device identifier may comprise many formats. For example, if the gaming device is a personal computer that communicates with controller 205, the gaming device identifier may be an Internet Protocol (“IP”) address of the computer.

Note that, in embodiments where the game play database is stored in the memory of a gaming device, the information stored in the game play database may indicate only game plays conducted on that gaming device. Accordingly, in such embodiments the gaming device identifier field may be unnecessary.

Note further that, in one or more embodiments, a result of a game other than a final score may be stored in the game play database. For example, a dollar value or other numerical indicator of a prize won by a player as a result of a game play may be stored in the game play database. In another example, a binary indication (e.g., “yes” or “no”) of whether a prize was won as a result of a game play may be stored in the game play database. In yet another example, an indication (e.g., a description or identifier) of which particular prize, if any, was won as a result of a game play may be stored in the game play database.

The game play database 330 may store information about game plays conducted within a predetermined period of time. For example, information about game plays conducted since a previous evaluation of results of game plays may be stored. In another example, information about game plays conducted since the last adjustment of a game may be stored.

A game play database may be utilized, for example, to track results of game plays conducted by means of the system 200. In some embodiments, as depicted in FIG. 6A, the game play database may store information about game plays of a plurality of different games. In other embodiments, the game play database may store information associated with game plays of a particular game only.

The tracked results may, in turn, be evaluated to determine whether a range of the results satisfies one or more predetermined criteria (e.g., whether the results fit into a desired predetermined and desired range of results). The evaluation of results may be performed on a periodic or non-periodic basis, as described herein. For example, an evaluation of game results to determine whether they fit into a desired predetermined range may be performed when a condition for triggering the evaluation is determined. Examples of conditions that may trigger such an evaluation are described in detail below. For example, in an embodiment where information about game plays for a plurality of games is stored, the occurrence of a particular condition for a given game may trigger a search for records of all game plays associated with the game identifier of that game. In embodiments where the game play database stores information on game plays of a particular game that are not relevant to the current evaluation (e.g., the game play occurred before a previous adjustment, that is currently in effect, was executed), the search may include other criteria to exclude records of irrelevant game plays. For example, the search may specify a time within which the game play must have been conducted or initiated.

The game play database may also store other information about game plays conducted on the system 200, such as the difficulty of a game played (e.g., a difficulty level of the game or a difficulty rating of the game as compared to other games), details about how a player played a game (e.g., particular actions the player took to achieve certain events), teammates or opponents of the player in a multi-player game, and the entry fee for a game.

Not all of the fields depicted in FIG. 6A are required, and various substitutions, deletions and other changes to the tabular representation will be readily apparent to those of ordinary skill in the art.

Referring now to FIG. 6B, a tabular representation 650 illustrates an example record of another embodiment of a game play database 330. The game play database 330 embodied in tabular representation 650 stores more detailed information about a game play than does a record of the game play database embodied in tabular representation 600. In particular, the tabular representation 650 stores an indication of particular events achieved by a player during a game play and information on how the achievement of these events contributed to the final score of the game play.

The record 650 includes a number of example fields, each field indicating information related to the game play of the record. The fields include (i) a game play identifier 652 that uniquely identifies the game play; (ii) a game identifier 654 that identifies the game that was played; (iii) a player identifier 656 that identifies the player who participated in the game play (note that for multi-player games this field may store a plurality of player identifiers); (iv) a start time 658 that indicates the time at which the game play began; (v) an end time 660 that indicates the time at which the game play ended; (vi) a status 662 that indicates a current status of the game play (e.g., “in progress” or “completed”); (vii) a final score 664 of the game play; (viii) an event(s) achieved 666 that stores an identifier of an event achieved during the game play; (ix) a number of occurrences of the event 668 that indicates how many of the event identified in field 666 were achieved during the game play; (x) a points per event occurrence 670 that indicates how many points were added to the player's score for each occurrence of the corresponding event; and (xi) a points for event 672 that indicates the total number of points added to the player's final score for all of the occurrences of the corresponding event (determined to be the product of the number of occurrences of the event and the points awarded per occurrence of the event). A person of ordinary skill in the art, after reading the description of the invention, would recognize that other information may be stored in the game play database in addition to or in lieu of the information represented in record 650.

Not all of the fields depicted in FIG. 6B are required, and various substitutions, deletions and other changes to the tabular representation will be readily apparent to those of ordinary skill in the art.

As described briefly above, in one or more embodiments adjusting a game may comprise adjusting a number of points awarded for achievement of particular events during a game play of the game. Following is an example of how a game may be adjusted in such a manner that an expected standard deviation of expected results of future game plays of a game more closely approximates a desired standard deviation.

### EXAMPLE

Assume the following events may be achieved in a game and the following corresponding points are awarded for a respective achievement of each event:

TABLE 1

| Event | Points |
|---|---|
| A | 25 |
| B | 25 |
| C | 50 |
| D | 50 |
| E | 200 |
| F | 500 |

Further assume that the following players P1-P10 achieved the following number of each of the above events A-F in a respective game play:

TABLE 2

| | #A | #B | #C | #D | #E | #F |
|---|---|---|---|---|---|---|
| P1 | 22 | 15 | 11 | 3 | 0 | 0 |
| P2 | 19 | 12 | 9 | 2 | 1 | 0 |
| P3 | 25 | 18 | 25 | 2 | 1 | 0 |
| P4 | 23 | 12 | 17 | 8 | 6 | 0 |
| P5 | 26 | 15 | 18 | 10 | 8 | 0 |
| P6 | 25 | 19 | 18 | 10 | 12 | 0 |
| P7 | 28 | 17 | 19 | 11 | 11 | 0 |
| P8 | 26 | 19 | 20 | 13 | 13 | 5 |
| P9 | 27 | 16 | 23 | 14 | 12 | 6 |
| P10 | 25 | 24 | 18 | 12 | 12 | 4 |

Assuming that the achievement of events A-F is the only means for a player to add points to his score for the game of the present example, the final score of each player P1-P10 is illustrated in Table 3 below:

TABLE 3

| Player | Final Score |
|---|---|
| P1 | 1625 |
| P2 | 1525 |
| P3 | 2125 |
| P4 | 3325 |
| P5 | 4025 |
| P6 | 4900 |
| P7 | 4825 |
| P8 | 7875 |
| P9 | 8325 |
| P10 | 7125 |

Standard Deviation of above scores = 2527.52

In the above example Table 3, the final score for a respective player is calculated by summing the products of the number of points awarded for each event and the number of each event achieved by the player. For example, the final score for player P1 was calculated as follows:

final score for player P1

$$final score for player P1 = [ ( 22 ) ( 25 ) ] + [ ( 15 ) ( 25 ) ] + [ ( 11 ) ( 50 ) ] + [ ( 3 ) ( 50 ) ] + [ ( 0 ) ( 200 ) ] + \\ [ ( 0 ) ( 500 ) ] = [ 550 ] + [ 375 ] + [ 550 ] + [ 150 ] + [ 0 ] + [ 0 ] = 1625$$

The standard deviation of the above scores, using the formula for determining standard deviation described in detail below, is 2527.52.

Assume that the predetermined criteria that the above scores must satisfy comprises a range of a desired standard deviation, the range being 1500-1750. In other words, the gaming establishment operator (or other entity that establishes the predetermined criteria for the game) desires that the standard deviation of scores for the game fall within a range of standard deviations of 1500-1700. The standard deviation of 2527.52 is outside of this desired range. Accordingly, assume that the game is adjusted such that expected scores for future game plays of the game will fall within the range governed by a desired standard deviation. Further assume that the method for adjusting the game comprises adjusting the number of points awarded per event in the game (events A-F).

The achievement of the above events may be evaluated to determine which events would be most effective in adjusting the standard deviation of scores. Assuming the scores of the above players are representative of how many times each event is typically achieved by players of varying skill and experience levels, it can be seen that most players achieve at least 20 but no more than 30 occurrences of event A, most players achieve at least 10 occurrences but no more than 20 occurrences of events B and C, there is a greater disparity amongst players in the achievement of event D (some players achieving fewer than 10 occurrences while other players achieving almost 20 occurrences) and few players achieving even a small number of occurrences of event E and event F.

The goal in this example is to reduce the standard deviation of the scores and thus reduce the disparity in the scores. Accordingly, the most effective method for doing so appears to be to (i) increase the number of points awarded for the events frequently achieved by most players, regardless of skill or experience level, and (ii) decrease the number of points awarded for events rarely achieved by any player. Thus, the number of points awarded for event A and event B should be increased while the number of points for event E and event F should be decreased.

Based on the above analysis, assume that the number of points awarded per event is adjusted to the following values:

TABLE 4

| Event | Points |
|---|---|
| A | 100 |
| B | 100 |
| C | 50 |
| D | 50 |
| E | 50 |
| F | 250 |

As can be seen from the above table, the number of points awarded has been (i) increased for an occurrence of event A from 25 points to 100 points; (ii) increased for an occurrence of event B from 25 points to 100 points; (iii) unchanged for an occurrence of event C and event D, respectively; (iv) decreased for an occurrence of event E from 200 points to 50 points, and (v) decreased for an occurrence of event F from 500 points to 250 points.

As described above, the adjustment of a game is executed for the purpose of affecting expected scores for future game plays of a game and does not affect previous scores of game plays already completed. However, assuming again that the number of each event achieved by the players P1-P10 is representative of a number of each event typically achieved by players of varying skill level, the adjusted number of points as illustrated in Table 3 can be applied to the number of occurrences of each event by each player in order to illustrate an expected standard deviation of expected scores for future game plays of the game.

TABLE 5

| Player | Final Score |
|---|---|
| P1 | 4400 |
| P2 | 3700 |
| P3 | 5200 |
| P4 | 3325 |
| P5 | 4025 |
| P6 | 4900 |
| P7 | 4825 |
| P8 | 5050 |
| P9 | 5900 |
| P10 | 6400 |

Standard Deviation of above scores = 1595.31

In the above example Table 5 (as in Table 3), the final score for a respective player is calculated by summing the products of the number of points awarded for each event and the number of each event achieved by the player. However, in Table 5 the final score is calculated using the adjusted number of points awarded per event, as shown in Table 4. For example, the final score for player P1 was calculated as follows:

final score for player P1 (if P1 had played game after points adjustment)

$$final score for player P1 ( if P1 had played game after points adjustment ) = \\ [ ( 100 ) ( 22 ) ] + [ ( 100 ) ( 15 ) ] + [ ( 50 ) ( 11 ) ] + [ ( 50 ) ( 3 ) ] + [ ( 50 ) ( 0 ) ] + \\ [ ( 250 ) ( 0 ) ] = [ 2200 ] + [ 1500 ] + [ 550 ] + [ 150 ] + [ 0 ] + [ 0 ] = 4400$$

The standard deviation of the final scores in Table 5 is 1595.31 This is within the desired range of 1500-1700. Accordingly, if the number of occurrences of each event per game play remains about what it was for the past game plays of players P1-P10, the expected standard deviation of future scores is expected to satisfy the predetermined criteria for the game.

Note that in the above example, substantial adjustments were made in the number of points awarded for some of the events (e.g., the number of points for an occurrence of event A was adjusted from 25 points to 100 points). This is due to the small number of events that contributed to the scores of the example. In some games, dozens, hundreds or more events may contribute to a score for a game play. In such games, smaller adjustments may be sufficient as there are more events that may be adjusted.

The adjustment in the number of points for an event may be determined in a variety of manners. For example, in one embodiment the number of points for each event or a selected subset of events (e.g., the events frequently achieved by most players) may be adjusted (e.g., by predetermined increments) in an iterative fashion and the expected standard deviation calculated after each adjustment. This process may be continued until a set of point values is determined that results in an expected standard deviation that satisfies the one or more predetermined criteria of a game. In another example, a suggested value by which the number of points for an occurrence of a particular event is to be incremented or decremented may be stored in a memory (e.g., in association with a particular goal, such as an increase or decrease in the standard deviation of scores). In such an embodiment the number of points for an event may be incremented based on the stored value.

Game Database

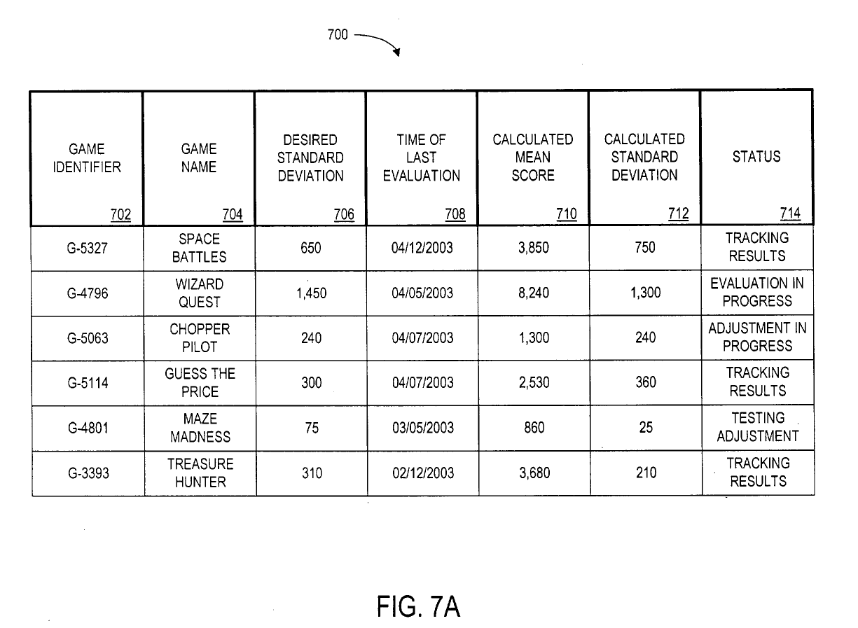

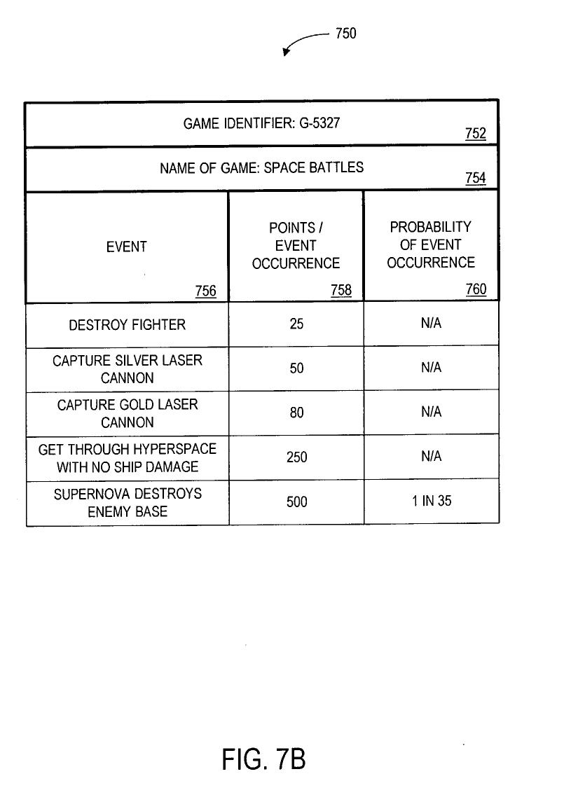

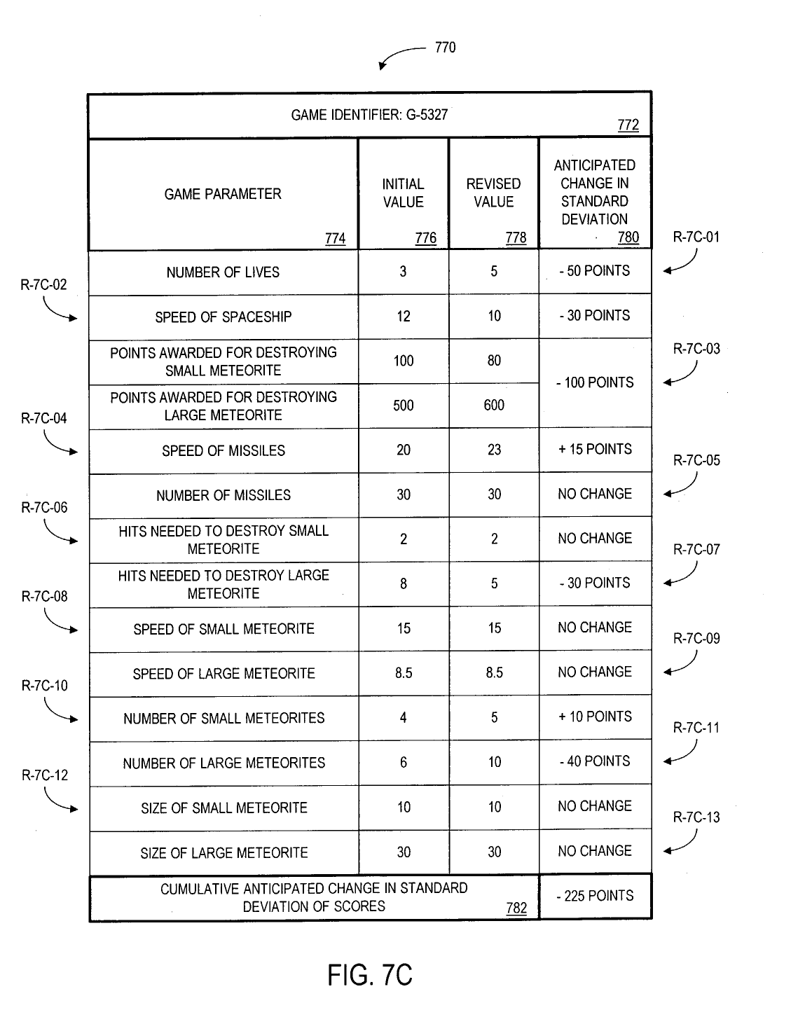

The following FIGS. 7A-7C each respectively illustrate an embodiment of the game database 335. A game database 335 may store information about a particular game available on system 200. The information in game database 335 may be utilized, for example, to determine whether an evaluation of results for game plays of the game should be determined and/or whether a range of results for the game satisfies one or more predetermined criteria, which may be stored for one or more games in the game database 335.

Referring now to FIG. 7A, an exemplary tabular representation 700 illustrates an embodiment of a game database 335. The tabular representation 700 of the game database 335 includes a number of example records or entries, each indicating a game available on a gaming device of system 200. Those skilled in the art will understand that the game play database may include any number of entries. The tabular representation 700 defines fields for each of the entries or records. The fields specify: (i) a game identifier 702 that uniquely identifies the game; (ii) a game name 704 that indicates the name by which players know the game; (iii) a desired standard deviation 706; (iv) a time of the last evaluation 708; (v) a calculated mean score 710 that indicates the mean score calculated at the last evaluation; (vi) a calculated standard deviation 712 that indicates the standard deviation of scores calculated at the last evaluation; and (vii) a status 714 that indicates the status of the game as relevant to an evaluation. Regarding the status 714, a status may indicate, for example, whether scores of the game are currently being evaluated, whether the game is currently being adjusted, whether an adjustment of the game is currently being tested, or whether scores for game plays of the game are currently being tracked. Other applicable statuses would be obvious to one of ordinary skill in the art after reading the present description of the invention.

Note that in the embodiment illustrated in FIG. 7A, a single respective predetermined criterion is specified for each respective game. In the embodiment illustrated in FIG. 7A, the predetermined criterion is a desired standard deviation. Note further that each respective game may have a different desired standard deviation. As described above, a predetermined criterion is a criterion that a set of results must satisfy, otherwise an adjustment of the game is necessitated such that a subsequent set of results (expected results of future game plays of the game) is expected to satisfy the criterion. In other embodiments, other predetermined criteria may be used and thus different information may be stored in the game database 335. For example, in one or more embodiments a desired variance of results may be the predetermined criteria for a game. In such an embodiment, a desired variance and a calculated variance may be stored instead of a desired standard deviation and a calculated standard deviation, respectively.

Note that in one or more embodiments, different games available on system 200 may be associated with different types of predetermined criteria. For example, a first game may be associated with a desired standard deviation while a second game may be associated with a desired variance and a desired mean result.

Although a particular number is indicated as a desired standard deviation, in other embodiments a desired range into which a standard deviation is desired to fit may instead be specified. For example, instead of a desired standard deviation of “650”, a desired range of “500-750” may instead be specified. Similarly, the gaming device 210 or controller 205 may be programmed with a predetermined range that is to be applied to each standard deviation in determining whether a set of results satisfies the standard deviation. For example, the gaming device 210 or controller 205 may be programmed with a predetermined range of “+/−50 points”. Thus, if a desired standard deviation is “650” then a set of results will be determined to satisfy the standard deviation if the calculated standard deviation for the set of results is anywhere between “600” and “700”.

In one or more embodiments, an additional rule defining the number stored in the standard deviation may be utilized in one or more embodiments. For example, a predetermined criterion may comprise a minimum threshold below which a standard deviation of results is not to be. For example, rather than simply storing “650” as a desired standard deviation (in which case any standard deviation other than “650” or outside of a predetermined range of “650” may be deemed as unsatisfactory), a record may indicate “≧650”. The latter indication specifies that any standard deviation greater than or equal to “650” is satisfactory.

Note that information stored in the embodiment of the game database illustrated in FIG. 7A may be calculated using information stored in the game tracking database 330. For example, the controller 205 may access the game play database 230 to determine a set of scores achieved for a particular game. The controller may determine the standard deviation in scores and the mean score. The calculated standard deviation of the scores and the calculated mean of the scores may then be stored in the record of the game in the game database 335.

Not all of the fields depicted in FIG. 7A are required, and various substitutions, deletions and other changes to the tabular representation will be readily apparent to those of ordinary skill in the art. For example, the table 700 could also store, for each respective game or a subset of games, a desired mean or median score (or range thereof) and/or one or more conditions that trigger an evaluation of a set of scores. Conditions which may trigger an evaluation of results of a game are discussed in detail below.

Referring now to FIG. 7B, an exemplary tabular representation 750 illustrates an embodiment of a record of the game database 335. In the embodiment illustrated by record 750, a game comprises a plurality of events, wherein a player is awarded a predetermined number of points for each occurrence of one of the events during a game play of the game. This embodiment is similar to that described with respect to FIG. 6B (an embodiment of the game play database 330).

The tabular representation 750 of the game database 335 includes a number of fields, each field indicating information relevant to the game of the record 750. Those skilled in the art will understand that the record of game database 335 may include any number of fields. The fields of record 750 specify: (i) a game identifier 752 that uniquely identifies a game; (ii) a name of the game 754 that indicates the name by which players recognize the game; (iii) an event 756 that indicates an event for which points are added to the player's score; (iv) a points/event occurrence 758 that indicates the number of points to be added to the player's score for each occurrence of the corresponding event; and (v) a probability of occurrence 760 that indicates the probability of the event occurring, if applicable to the nature of the event.

The embodiment of the game database 335 illustrated in FIG. 7B may be useful, for example, in embodiments where a game may be adjusted by adjusting a number of points awarded per occurrence of an event and/or by adjusting a probability of an event's occurrence. An example of the former was described with respect to FIG. 6B above. In that example, a decision was made to adjust the number of points awarded per occurrence of an event. Once such a decision is made for a particular game, the record of the game in the game database 335 may be accessed and the adjusted number of points awarded for each event may be stored. For example, the current number of points for a given event may be replaced with the adjusted number of points. In another embodiment, both the number of points before the adjustment and the number of points after the adjustment may be stored (at least temporarily, e.g., until a determination is made of whether the adjustment of the game was successfil).

In one or more embodiments, the occurrence of one or more events in a game may be governed at least partly by chance. This may be instead of or in addition to being governed by player skill. For those events the occurrence of which is governed at least partly by chance, one method of adjusting the game may be to adjust the probability of the event's occurrence. For example, in one game that may be available on the system 200, a player may be awarded a number of points if a random bonus event occurs during a game play. The probability of the event occurring may be adjusted to control how often players are awarded these points.

Note that only one number of points and one probability, if any, is associated with each event in record 750. In other embodiments, the number of points awarded for the achievement of an event and/or the probability of an event's occurrence may differ from one difficulty level of a game to another. In such embodiments, the record 750 may store a plurality of number of points awarded and/or a plurality of probabilities for each event, each respectively being associated with a particular difficulty level of a game.

Not all of the fields depicted in FIG. 7B are required, and various substitutions, deletions and other changes to the tabular representation will be readily apparent to those of ordinary skill in the art.

Referring now to FIG. 7C, an exemplary tabular representation 770 illustrates an embodiment of a record of game database 335. The tabular representation 770 of the game database 335 includes a number of fields, each indicating information relevant to a particular game available on a gaming device 210 of the system 200. The embodiment of tabular representation 770 may be useful, for example, for a controller to track adjustments to game parameters that have been executed. For example, the controller 205 may determine whether a standard deviation of actual results achieved after an adjustment of a game comports with the anticipated change in standard deviation as stored in table 770 and make further adjustments to the revised value(s) if they don't. The tabular representation 750 defines a number of fields. The fields specify: (i) a game identifier 772 that uniquely identifies a game; (ii) a game parameter 774 that indicates a parameter of a game available for adjustment; (iii) an initial value 776 that indicates a first value of a respective parameter; (iv) a revised value 778 that indicates a second value for the respective parameter; (v) an anticipated change in the standard deviation 780 that indicates an anticipated change in the standard deviation of scores if the value of the respective parameter is adjusted from the initial value to the revised value; and (vi) a cumulative anticipated change in standard deviation 782 that indicates the total anticipated change in the standard deviation of future scores due to all of the adjustments indicated in the record.

As described above, a game may include one or more game parameters. These game parameters may be variables that affect the performance, scoring, difficulty, outcome, or other aspects of the game. Examples of game parameters include:

(i) factors that affect the difficulty of a game (e.g., complexity of a game, hints provided, the sensitivity of controls, difficulty of trivia questions, number of opponents);

(ii) a number of points awarded for an achievement of a particular event in a game (e.g., 200 points for killing a monster, 300 points for solving a puzzle);

(iii) factors that affect a player's ability to score points in a game (e.g., maximum number of points possible, number of bonus items available);

(iv) rules of a game (e.g., number of strikes allowed in a baseball game, cost of vowels in a word guessing game);

(v) factors that affect the duration of a game (e.g., a number of rounds, a number of lives);

(vi) factors that affect the entertainment value of a game (e.g., quality of animation, background music);

(vii) a seed value for a random number generator;

(viii) algorithms that control how points are awarded (e.g., a formula for the number of bonus points that a player receives at then end of a round of a game play or at the end of a game play);

(ix) algorithms for adjusting a game based on a player's rating (e.g, a game may be adjusted to be more difficult for an expert-level player);

(x) algorithms that control computer opponents (e.g., a number of moves that a computer opponent looks ahead in chess); and

(xi) an amount of time that a player is allowed to achieve an event in a game or complete a game play of the game.

The tabular representation 770 illustrates some game parameters that are available for adjustment in the game “G-5327”. Note that this is the same game of the record 750 (FIG. 7B) and named “Space Battles”. However, in contrast to the embodiment of FIG. 7B, where a game was adjusted by adjusting how a player's achievements of various events during a game play are scored, in the embodiment of FIG. 7C a game is adjusted by adjusting how a game play is conducted. The initial value 776 indicates a value associated with a given parameter before an adjustment of the game is executed. The revised value 778 associated with a given parameter after an adjustment of the game is executed.

In the example illustrated in record 750, assume that the one or more predetermined criteria that a set of results of a game are to satisfy is a desired standard deviation range. Assume further that the controller 205 (or another device operable to adjust the game) has determined that the standard deviation of a set of results for the game of record 750 is too high and should be decreased by approximately 235 points for a future set of results. In the example illustrated by table 770, to decrease the standard deviation of future results obtained during future game plays of the game, the controller 205 has adjusted various game parameters. For example, as shown in row R-7C-01 of table 770, the controller 205 has increased the number of lives in the game from “3” to “5”. As indicated in the anticipated change in standard deviation field 780 of row R-7C-01, the anticipated change in the standard deviation of a set of future scores due to this change is a decrease of fifty points.

Note that an adjustment of more than one game parameter may be accounted for by a single combined anticipated change in the standard deviation. Field 780 of row R-7C-03 illustrates such an effect. The adjustment of the number of points awarded for “destroying small meteorite” has been decreased from “100 points” to “80 points” while the number of points awarded for “destroying large meteorite” has simultaneously been increased from “500 points” to “600 points”. The anticipated change in the standard deviation of future scores due to this combined adjustment of the two game parameters is a decrease of “100 points”. In this example, it is not necessarily undetermined what would happen if the controller 205 were to adjust only one of these game parameters.

Note that, even though the goal of the example of table 770 is to decrease the standard deviation of future scores, some of the individual adjustments to respective game parameters illustrated are expected to result in an increase in the standard deviation of future scores. Row R-7C-04 illustrates such an adjustment.

The anticipated cumulative effect of the adjustments made by the controller 205 is determined by summing the results of each of the individual adjustments. In example illustrated by table 770, the anticipated cumulative change in standard deviation in expected future results is a decrease of 225 points. This anticipated change may, in one or more embodiments, satisfy the goal of decreasing the standard deviation by approximately 235 points.

In one or more embodiments, the controller 205 (or another device, as appropriate) may verify that an adjustment of a game is successful. For example, the controller 205 may adjust a game such that an expected standard deviation of future scores should be less than a calculated standard deviation of previously obtained scores by an approximate specified amount. After the adjustment of the game is executed, the controller 205 may track results obtained by players during game plays conducted under the adjusted game parameters (e.g., in the game play database 330). Using this data, the controller 205 may determine a standard deviation of the results obtained under the adjusted game parameters and determine whether this standard deviation does in fact meet the goal of the adjustment or satisfy the one or more predetermined criteria associated with the game. For example, the controller 205 may compare the calculated standard deviation to the cumulative anticipated change in standard deviation 782. If the adjustment of the game was not completely successful, another adjustment may be performed.

Note that in this manner, the controller 205 may use feedback to determine which modifications are most successful in altering the standard deviation (or another measure) of results for a game. For example, in determining which game parameters to adjust in a subsequent adjustment of a game and/or in determining a new value for a game parameter to be adjusted, the controller 205 may access information about the success of previous adjustments and base the determination on this information. For example, if the controller 205 determines that, for a particular game, an increase in the number of lives from “3” to “5” does typically result in a decrease in standard deviation of “50 points”, the controller 205 may select this adjustment to implement if such a result is desired in a current adjustment of the game.

Note that, once an adjustment of a game is finalized (e.g., the controller has verified that the adjustment was successful), the record of the adjustment for the game may be closed. In such embodiments, the record 770 may further store an indication of the time of the adjustment and/or an indication of whether the adjustment was determined to be successful. Alternately, the revised value may be stored as the initial value in the initial value field 776. The revised value field 778, the anticipated change in standard deviation field 780 and the cumulative anticipated change in standard deviation of scores field 782 may then be left blank (i.e., not store any values) until the next adjustment of the game.

Not all of the fields depicted in FIG. 7C are required, and various substitutions, deletions and other changes to the tabular representation will be readily apparent to those of ordinary skill in the art.

Available Game Adjustments Database

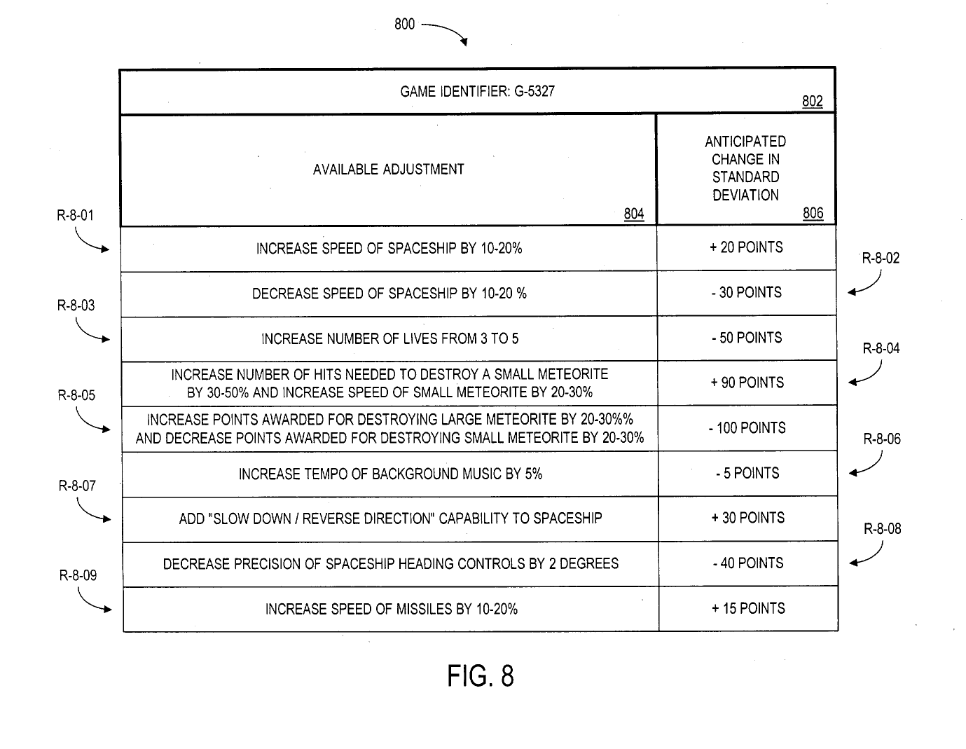

Referring now to FIG. 8, a tabular representation 800 illustrates an example record of an embodiment of an available game adjustments database 340. The record 800 includes a number of example fields, each field indicating information related to an adjustment that may be made to a game (e.g., in order to maintain results of game plays of the game within a predetermined range). The fields include (i) a game identifier 802 that uniquely identifies the game; (ii) an available adjustment 804; and (iii) an anticipated change in standard deviation 806 that indicates the expected change in the standard deviation of results of game plays of the game if the corresponding adjustment is made.

The record 800 stores a variety of possible adjustments that may be made by the controller 205 to a particular game, along with the anticipated consequences of these modifications. The controller 205 may utilize the available game adjustments database 340 to select one or more game parameters to be adjusted for a game as well as to determine a new value for the game parameter selected to be adjusted. For example, if controller 205 determines that the one or more predetermined criteria associated with a particular game has not been satisfied by a set of results for the game, the controller 205 may access the record of the game in the available game adjustments database 340 to determine how the game should be adjusted. For example, in the embodiment illustrated by FIG. 7B, the controller adjusted several game parameters in order to decrease the expected standard deviation for a set of future results for the game. One exemplary method for how the controller 205 may have selected the particular game parameters to adjust is illustrated in FIG. 8. For example, the controller 205 may select those game parameters that, based on the anticipated change in standard deviation associated therewith, will result in the desired change to the standard deviation.

For example, the table 800 illustrates in row R-8-03 that increasing the number of lives from “3” to “5” is expected to result in “50 point” decrease in the standard deviation. Referring again to FIG. 7C, row R-7C-01 illustrates that the controller 205 selected this game parameter for adjustment and stored the anticipated change in standard deviation from field 806 in table 800 in the anticipated change in standard deviation field 780 of table 770.

Note that some anticipated changes in the standard deviation of a set of future results may be based on assumptions about how a change will effect the play of a player of a first skill level versus a player of a second skill level. This is similar to the concept described with respect to the example described with respect to FIG. 6B above, where a number of points awarded for an occurrence of an event was decreased for those events that are achieved by some more skilled or experienced players but not at all achieved by novice or low skill players, in order to decrease the scores of the more experienced or skilled players while minimizing any decrease in scores of novice or low skill players. For example, in row R-8-01 of table 770 it is illustrated that increasing the speed of a player's spaceship by “10-20%” is anticipated to increase the standard deviation in results of the game by 20 points (e.g., because expert players will be able to take advantage of the speed difference and maneuver around meteorites more easily, while novice players may have difficulty controlling the spaceship at higher speeds). In a second example, row R-8-08 of table 770 illustrates that decreasing the precision of the heading controls for a player's spaceship may decrease the standard deviation of results achieved by players playing the game (e.g., since expert players will no longer be able to aim precisely enough destroy meteorites from a long distance away).

Information stored in the available game adjustments database 340 may be provided, for example, by an operator of the gaming establishment of controller 205. In another embodiment, the information may be determined by the controller 205 by monitoring game plays played by players (e.g., through data mining). In yet another embodiment, the information stored in the available game adjustments database 340 may be updated based on the determination by controller 205 whether an executed adjustment of a game was successful. For example, if controller 205 utilizes one or more of the available game adjustments stored in the available game adjustments 340 to adjust a game and then, upon testing the results obtained under the adjusted game, determines that a change in standard deviation due to a particular adjustment was different from the anticipated change in standard deviation, the controller 205 may alter the anticipated change in standard deviation to be the actual calculated change in standard deviation that resulted due to the change. Alternatively, the controller 205 may output a message to an employee of the gaming establishment, informing the employee of the discrepancy. The employee may then alter the value stored in the anticipated change in standard deviation field 806 if that is found to be desirable.

In the embodiment of the available game adjustments database 340 illustrated in FIG. 8 it is assumed that the effects of most adjustments to a game are substantially independent. That is, if the controller 205 were to make two of the available adjustments to the game, the resulting effect on the standard deviation of expected future results of the game would be the sum of the two effects that would result if each of the adjustments were made on their own. For example, table 800 indicates that if the controller 205 were to (i) increase the speed of a player's spaceship by “10-20%”, and (ii) increase the number of lives from “3” to “5”, then the cumulative anticipated effect would be to decrease the standard deviation of future results for the game by “30 points” (i.e., “20 points” minus “50 points”).

In one or more embodiments, individual adjustments to a game may be dependent on one another. For example, the table 700 indicates that in order to increase the standard deviation of future results by “90 points”, the controller 205 is to make two changes:

(i) increase the number of hits needed to destroy a small meteorite by “30-50%”, and

(ii) increase the speed of small meteorites by “20-30%”.

Not all of the fields depicted in FIG. 8 are required, and various substitutions, deletions and other changes to the tabular representation will be readily apparent to those of ordinary skill in the art.

Processes

In one or more embodiments, the controller 205 is operable to (i) enable a player to play a game; (ii) determine a set of results achieved over a plurality of game plays of the game; (iii) determine whether the set of results satisfies the one or more predetermined criteria associated with the game; and (iv) adjust the game based on the determination of whether the one or more predetermined criteria are satisfied. For example, the controller 205 may adjust the game if the results are not within a desired predetermined range (e.g., as defined by, for example, a desired standard deviation). Each of the above functions of controller 205 is described in detail below. This section concludes with a description of two exemplary processes, process 900 and process 1000, that may be carried out by controller 205 and a detailed description of two graphs, each graph respectively corresponding to one of the processes and illustrating an effect on results due to the respective corresponding process.

Enabling Game Play

In one or more embodiments, the controller 205 may host a Web site or other network-accessible gaming service. Players may log onto this Web site to play games and win prizes. According to another embodiment, the controller 205 may control a plurality of gaming devices in a brick-and-mortar gaming establishment such as an arcade. In yet another embodiment, the invention may be practiced on a single gaming device. In any and all of these embodiments, enabling game play may include, for example, (i) registration and entry fees; (ii) conducting one or more game plays; and (iii) outputting results of the one or more game plays (e.g., displaying a score and/or awarding prizes). For purposes of brevity, these processes will be described as being performed by controller 205. However, in any and all of the embodiments described below (as well as in any and all embodiments described above) a device other than controller 205 (e.g., a gaming device 210) may also be operable to perform any and all of the processes, or portions thereof, described herein as being performed by controller 205.

In one or more embodiments, the controller 205 may identify a player who would like to participate in a game. Identifying a player may include receiving an indication of information from a player such as a username, password, home telephone number, home address, network address (e.g., IP address), a financial account number (e.g., a credit card number) or another form of player identifier. The player may provide this indication using a player device that is different from a gaming device. Examples of a player device include a personal computer, a personal digital assistant (PDA), a cellular telephone, a pager, a magnetic stripe card, and a smart card. In other embodiments the player may enter a player identifier directly into the gaming device (e.g., by typing it into a keyboard of the gaming device or providing biometric data to a biometric identifier of the gaming device).

Information identifying a player may be useful in various ways. Examples include:

(i) A player's IP address may be useful in allowing the player to participate in a game play over the Internet.

(ii) A player's username and password may be useful in preventing somebody else from masquerading as the player.

(iii) A player's home address may be useful for providing a bonus to the player (e.g., by mailing a prize or check to the player).

In one or more embodiments, a player may pay an entry fee for a game play. This entry fee may be optional or required. Examples of entry fees include:

(i) money and other currencies. For example, a player may pay $0.25 per game play of a game. In a second example, a player may pay ten electronic credits per game play of a game. Examples of alternate currencies include tickets, credits, points, Beenz, frequent flyer miles, and minutes of long distance phone time. In one embodiment, a player may purchase an alternate currency (e.g., tickets) using money or some other form of consideration.

(ii) other forms of consideration (e.g., providing services or products, performing activities, viewing advertisements).

In one or more embodiments, a player may provide a payment identifier (e.g., a financial account identifier) to pay an entry fee for a game play. Examples of payment identifiers include:

(i) a credit card number

(ii) a debit card number

(iii) a checking account number

(iv) a billing address

(v) a PayPal™ account number

In one or more embodiments, an entry fee for one or more game plays may be paid at various different times. Examples include of times at which an entry fee may be paid include:

(i) An entry fee may be paid at the start of a game play. For example, a player may be asked to pay $0.50 to initiate a game play of “Space Battles”.

(ii) An entry fee may be paid after a game play is finished. For example, a player who just finished playing five game plays of “Space Battles” may be asked to pay $1.00 for these games plays.

(iii) An entry fee may be paid during a game play. For example, a game play of “Guess the Price” may pause and prompt a player, “If you want to continue, please click here to pay $0.25.”

(iv) An entry fee may be paid over time. For example, a player may be billed at a rate of $0.25 per hour for playing games.

(v) An entry fee may be paid when a player purchases a prize with points or another currency the player won while playing games. For example, a player may be permitted to play game plays for free and earn points for winning these game plays. These points may in turn be used as an alternate currency to purchase prizes. However, in order for a player to purchase a prize using points that he has won, he may be required to pay the entry fees for one or more of the games plays that he has played.

In one or more embodiments, entry fees may be different for different games. For example, it may cost a player $0.25 to play a game of Pac-Man™, but $1.00 to play eighteen holes of golf in a virtual golf game.

In one or more embodiments, a two or more players may cooperate or compete against one another in a single game play. In such an embodiment, the two or more players may share an entry fee for the game play. For example, Alice and Bob may decide to work together to solve a crossword puzzle. If an entry fee for a single-player crossword puzzle is normally $2.00, Alice and Bob may split this fee between them and each pay $1.00. Alternatively, they could split the entry fee unevenly; Alice might pay $0.50, while Bob might pay $1.50. If Alice and Bob win a prize in the game play, they may split the prize using one or more agreed-upon rules (e.g., prize is split 50%-50%, prize is split according to ratio of entry fees paid by the players, prize is split according to which player scored the most points).

As described above, in one or more embodiments the controller 205 may enable a player to play one or more games. Examples of games that may be played by a player on the system 200 include:

(i) single-player games (e.g., crossword puzzles, Pac-Man™, Solitaire)

(ii) player vs. player games (e.g., chess, Scrabble™, poker)

(iii) team games (e.g., bridge, Gauntlet™)

(iv) games of skill (e.g., trivia, Quake™, Scrabble™, mazes)

(v) games of chance (e.g., blackjack, bingo)

In one or more embodiments, the controller 205 may receive a selection of a game that a player would like to play. For example, a player may use a player device or a gaming device to select a game that he would like to play from a list of available games.

In one or more embodiments, the controller 205 may transmit information to a gaming device to be displayed to a player via an output device of the gaming device. For example, the controller 205 may transmit an image of a plurality of products and request that the player order the products from most to least expensive. In a second example, an audio recording of descriptions of the products may be output to a player through a gaming device that is the player's cellular telephone. In embodiments where the gaming device comprises a gaming console in a brick-and-mortar gaming establishment, game information may be stored locally in the gaming device. In such embodiments, the controller may simply direct the gaming device to initiate the requested game.

In one or more embodiments, the controller 205 may receive one or more game inputs from a player, which may affect the game play. For example, a player may use a keyboard on a personal computer to answer a trivia question. In a second example, a player may use a joystick attached to a set-top box to control a race car in a game.

In one or more embodiments, the controller 205 may determine an outcome for a game play played by a player. The outcome may be based on inputs provided by the player as well as other factors related to the game play (e.g., rules of the game, inputs by other players, random numbers).

In one or more embodiments, the controller 205 may provide one or more prizes to a player as a result of a game play. A prize may be any form of consideration, including currencies (e.g., money), products, and services. For example, a player may be able to “purchase” prizes using points scored in one or more games. In another example, the player may win a prize directly based on a result of a game play (e.g., if the player lands in the center of a bulls eye in a target game, the player wins currency that may be used to offset a purchase of a product). Examples of prizes that a player may win as a result of a game play include:

(i) money and other currencies (e.g., tickets, credits, points, Beenz, frequent flyer miles, and minutes of long distance phone time);

(ii) products (e.g., a toaster oven);

(iii) services (e.g., a free game, a free or discounted car wash, access to premium gaming services); and

(iv) other forms of consideration.

In one embodiment, a player may combine points that are scored in multiple different games to purchase a single prize. Points scored based on achievement of events during a game play of a first game may be equivalent to points scored for achievements of events during a game play of a second game.

Alternatively, points that are scored in a game may be converted into credits or money that may be used to purchase prizes. For example, player may score 12309 points in a game play of a trivia game. These 12309 points may be converted to 3200 credits using a function or a conversion table. The player may then use these 3200 credits to purchase prizes. According to one embodiment, points may be converted into credits in such a manner that most point values convert to approximately the same value in credits. For example, the following formula may be used to convert points to credits, money or some other currency used to purchase prizes:

(number of credits)=1000+100*(points scored)/(maximum points possible in game)

By using a formula like the one immediately above to convert points into credits, the controller 205 may ensure that most players will receive the same number of credits and low skill or novice players will not be discouraged (e.g., all players will win approximately 1000 credits per game).

In one or more embodiments, a prize comprising an amount of currency may be credited to an account associated with a player. For example, a player may win $3 in a game play of a trivia game. This money may be stored in a bank account associated with the player, the account being identified by a payment identifier (e.g., a bank account number). In a second example, a player may win 3400 points in a game play of a game and these points may be credited to his account in a player database stored by the controller 205 (e.g., the player database 325).

Determining a Set of Results

As described above, the controller 205 determines a set of results obtained over a plurality of game plays of a game. This determination may involve selecting the set of results. For example, the controller 205 may retrieve the set of results from a game play database, such as that embodied in FIG. 6A and FIG. 6B. If the game play database stores information on game plays of more than one game, the controller 205 may search the database for results of game plays of the game for which the evaluation of results is currently being performed.

The controller 205 may further limit the search by using one or more selection conditions to select results to be included in the set. For example, this selection condition may be a Boolean expression; only games for which the selection condition is true will be included in the data set. The game plays database 330 may be searched to select those game plays which meet the specified selection condition. Examples of selection conditions include:

(i) (GAME_TYPE = “Space Battles”) AND
(START_TIME > “Mon, 12/10/01, 5pm”);
(ii) (PLAYER_TYPE = “Expert”) OR (PLAYER_TYPE =

“Intermediate”); and

(iii) (ENTRY_FEE = “2 Tokens”) AND
(PLAYER_TYPE = “Beginner”).

As illustrated above, one selection condition may be a period of time during which the results have been obtained. For example, the controller 205 may determine a time of the last evaluation of the results of the game (which may be stored in a game database, such as illustrated in table 700 of FIG. 7A) and search only for results of game plays that have been obtained since that time. In another example, the controller 205 may randomly select a predetermined number of representative results that have been obtained since the time of the last evaluation. In yet another example, the results may be evaluated to determine whether any of the results are outlier results (e.g., so far removed from the majority of the results as to be statistically irrelevant) and discard those outlier results from the set of results for which a range is to be determined. In one or more embodiments, the set of results evaluated by the controller may comprise all of the results obtained during game plays of the game, with no limiting criteria as to which results qualify for inclusion in the set. Example data sets include:

(i) all game plays played during a specific period of time (e.g., all game plays played in the last week, all game plays played within two weeks of a promotion);

(ii) all game plays played by a particular player;

(iii) all game plays played by a specific type of player (e.g., all game plays played by expert-level players);

(iv) all game plays played by new players (e.g., players who signed up within the last two weeks)

(v) all game plays played within a specific difficulty level of a game;

(vi) all game plays for which a specific entry fee was paid (e.g., all game plays that cost 2 tokens to play);

(vii) an intersection of two or more data sets (e.g., all “Space Battles” game plays played during the last week);

(viii) a union of two or more data sets (e.g., all game plays played by beginner level and average level players); and

(ix) all games played by players of a particular age or age bracket.

In one or more embodiments a characteristic of a game that is indicative of achievement in a game, other than a score or value corresponding to a prize, may be evaluated. For example, range in a number of levels completed, a number of lives lost, a total time spent playing, or a number of questions answered correctly may be determined and compared to one or more gaming predetermined criteria.

In one or more embodiments, multiple results may be associated with a single game play (e.g., multiple prizes or scores may be awarded in a single game play). In such an embodiment, each of the results may represent a separate element in the data set, or the results may be summed together to determine the total result for the game play. Alternatively, the results for a particular game play may be averaged to determine the mean result for the game play.

Determining Whether Set of Results Satisfies Predetermined Criteria

In one or more embodiments, the controller 205 may determine whether the set of results selected above satisfies the one or more predetermined criteria associated with the game. Such a determination may comprise, for example, determining the one or more criteria associated with the game. This may be accomplished by, for example, accessing a record of the game in the game database 435 (e.g., based on the game identifier) and retrieving the one or more predetermined criteria stored in the record.

Determining whether the set of results satisfies the one or more predetermined criteria may comprise evaluating the set of results in a predetermined manner. For example, the controller 205 may determine whether a variance of the set of results is (i) within a predetermined range; (ii) above or below a predetermined minimum threshold; or (iii) above or below a predetermined maximum threshold. In another example, the controller 205 may determine whether a standard deviation of the set of results is (i) within a predetermined range; (ii) above or below a predetermined minimum threshold; or (iii) above or below a predetermined maximum threshold. In yet another example, the controller 205 may determine whether a range of the results achieved is within a range defined by a predetermined number of a predetermined standard deviation of the mean result.

Evaluating a set of results may comprise, for example, calculating a variance in the results. In another example, a standard deviation of the results may be calculated. In yet another example, the lowest result may be determined as the lower bound of the range and the highest result may be determined as the upper bound of the range. Detailed exemplary calculations of how a set of results may be evaluated follow.

As described above, in one or more embodiments, a variance in results obtained by players may be calculated. For example, the controller 205 may determine the variance in results obtained in the game “Space Battles” by using the game play database 330 to determine all the results obtained for game plays of “Space Battles” during a predetermined period of time (e.g., the last month or since the last determination of variance in results). The controller 205 may then calculate the variance in this set of results. According to one embodiment, variance may be calculated using a formula such as:

$${σ}^{2} = \frac{1}{n} {\sum }_{i = 1}^{n} {( {X}_{i} - μ )}^{2}$$

where: ζ² is the variance

n is the number of elements in the set

i is the index of the current element

Xᵢ is the current element (e.g., the final score achieved in a game)

Π is the mean (average) value of the elements in the set

Note that Π (the mean value of the elements in the set) may be calculated using a formula such as:

$$μ = \frac{1}{n} {\sum }_{i = 1}^{n} {X}_{i}$$

According to one embodiment, the controller 205 may also calculate a standard deviation in results based on a calculated variance using a formula such as:

σₓ=\sqrt{σ²ₓ}=\sqrt{VAR(X)}=SD(X)

For example, if the one or more predetermined criteria comprises a desired standard deviation, the determination of whether the set of results satisfies the one or more predetermined criteria may comprise determining the standard deviation of the set of results and comparing it to the desired standard deviation. As described above, the controller 205 may be programmed with instructions as to how the one or more predetermined criteria may be satisfied. For example, the controller 205 may be programmed to determine the desired standard deviation to be satisfied if the calculated standard deviation for the set of results is within a predetermined range of the desired standard deviation.

In another example, the one or more predetermined criteria may comprise a desired mean result and a desired standard deviation in results. In such an example, determining whether the set of results satisfies the one or more predetermined criteria may comprise (i) calculating the mean result of the set of results, (ii) calculating the standard deviation of the set of results, (iii) determining whether the calculated mean result is within a predetermined range of the desired mean results, and (iv) determining whether the calculated standard deviation is within a predetermined range of the desired standard deviation.

As described, in one or more embodiments the controller 205 may determine whether a calculated variance in results for game plays of a game is too high or too low. Examples of determinations that may be made by the controller 205 include:

(i) The variance in results for a particular data set (e.g., a particular type of player, a particular difficulty level of a game) is too low (e.g., below a predetermined minimum threshold). If this occurs, then players may become bored because they typically achieve approximately the same result. To avoid this problem, the controller 205 may adjust a game to increase the variance in results.

(ii) The variance in results for a particular data set (e.g., a particular type of player, a particular difficulty level of a game) is too high (e.g., above a predetermined maximum threshold). If this occurs, then some players may become discouraged because the game is too unpredictable or because the results they achieve in the game are much less than the top level results in the game. In this case, the controller 205 may adjust the game to decrease the variance in results.

Note that, in one or more embodiments, each of the one or more predetermined criteria must be satisfied in order to avoid adjustment of the game. In other embodiments, only a subset of the one or more predetermined criteria must be satisfied (e.g., two out of three or at least the first two) in order to avoid adjustment of the game.

Of course, as described above, in one or more embodiments a result of a game play that is to be included in a data set to be evaluated may be in a form other than a score or number of points. In such embodiments, evaluating the results in a data set to determine whether the results satisfy the one or more predetermined criteria associated with a game may comprise converting the results to a useful form. For example, in one embodiment, a prize such as a product or service may be awarded to a player as a result of a game play. Such prizes may be awarded in addition to or in lieu of a score. For example, in one embodiment a first prize corresponds to a first range of scores that a player may achieve in one or more game plays of the game (e.g., a score of 500-1000 points) while a second prize corresponds to a second range of scores that a player may achieve in one or more game plays of the game (e.g., 1001-1500 points). In another embodiment, a prize may be awarded if a player achieves a particular event or level of achievement in one or more game plays of a game (e.g., the player gets to level 3 of the game within two consecutive game plays). In embodiments where a prize is awarded as a result of a game play, the prizes may first be converted to numerical values before the set of prizes is evaluated. For example, a dollar value or point value for each prize may be determined (e.g., based on the cost or worth of the prize) and a range of the dollar or point values may be determined. In another example, a monetary value may be provided as a prize (e.g., a ten dollar prize, a gift certificate for five dollars, a coupon for one dollar off a product or service). In such embodiments, a range of the monetary values provided to the players may be determined.

Adjusting the Game

If it is determined that a set of results for a game does not satisfy one or more predetermined criteria for the game, the controller 205 adjusts the game. Some examples of how a game may be adjusted have already been described above. Adjusting a game may comprise (i) determining the at least one goal of the adjustment; (ii) determining the one or more game parameters to be adjusted; (iii) determining a respective new value for each of the one or more game parameters to be adjusted; and (iv) executing the adjustment. In one or more embodiments, adjusting the game may further comprise testing the adjustment to determine whether the at least one goal of the adjustment has been met. Typically the at least one goal of the adjustment is to adjust the game such that expected results for future game plays of the game will satisfy the one or more predetermined criteria associated with the game.

For example, assume that the one or more predetermined criteria associated with a game is a desired standard deviation and that satisfaction of the one or more predetermined criteria comprises a calculated standard deviation of a set of results that is within a predetermined range of the desired standard deviation. In such an example the controller 205 may determine the amount by which the calculated standard deviation needs to be changed such that a standard deviation of expected results for future game plays will satisfy the desired standard deviation. For example, the controller 205 may determine that currently the standard deviation of results achieved during game plays of a game is “435 points”. The controller 205 may further determine that the desired standard deviation for results of the game is “650” points and that this desired standard deviation may be satisfied by a calculated standard deviation of results that is within “50 points” of the desired standard deviation. Accordingly, the controller 205 may determine that the game should be adjusted such that the standard deviation of expected results of future game plays is approximately “200 points” more than the calculated standard deviation of the results evaluated.

The controller 205 may use any of a variety of different methods to adjust a game such that expected results of future game plays satisfy the one or more predetermined criteria of the game. The following description illustrates two exemplary processes for adjusting a game.

Referring now to FIGS. 9A and 9B, depicted therein is a flowchart of an exemplary process 900 that may be used to adjust a game in accordance with one or more embodiments of the present invention. In the process 900 (as well as in the process 1000, described below) it is assumed that the process is being carried out for a particular game that has an associated predetermined criterion comprising a desired standard deviation. Other predetermined criteria may be added or substituted without departing from the spirit and scope of the embodiments illustrated by process 900 and the process 1000.

The results for a plurality of game plays of a game are tracked in step 902. Tracking the results may comprise, for example, monitoring one or more gaming devices to determine the results being achieved. Tracking the results may further comprise storing the results in memory (e.g., in game play database 930).

In step 904 it is determined whether one or more conditions that trigger an evaluation of results for the game have been satisfied. Each game available on system 200 may be associated with a different condition that triggers an evaluation of results, or the same condition(s) may trigger an evaluation of results for two or more games available on system 200. For example, in one embodiment the same single condition, if satisfied for any one game, may trigger an evaluation of results for the game. A condition that triggers an evaluation of results of a game may be specified, for example, by (i) an operator of a gaming establishment in which embodiments of the present invention are implemented; (ii) a provider of a prize that may be won by playing a game available on system 200; (iii) a designer of a game available on system 200; or (iv) a combination thereof.

Examples of conditions that may trigger an evaluation of results of a game include, but are not limited to:

(i) the passage of a predetermined period of time since a predetermined event (e.g., the last evaluation of results);

(ii) the occurrence of a predetermined time (e.g., midnight on a Sunday);

(iii) the occurrence of a predetermined number of game plays (e.g., a consecutive number of game plays or a number of game plays associated with a predetermined characteristic) since a predetermined event (e.g., the last evaluation of results);

(iv) a predetermined activity level of a gaming device;

(v) a determination that a particular player or a predetermined number of players who have previously played a game have not returned within a predetermined period of time to play the game again;

(vi) a signal received from an employee of the gaming establishment operating system 200; and

(vii) a predetermined number of requests and/or complaints being received from players of the game.

Alternatively, an evaluation of results for a game may be performed continuously or at random intervals.

If it is determined that a condition that triggers an evaluation of results for a game has been satisfied, the process 900 continues to step 906. Otherwise, the process 900 returns to step 902, where results of the game continue to be tracked.

A set of results to be evaluated are selected in step 906. Various methods of selecting a set of results for evaluation are described in detail above. An additional exemplary method comprises outputting a request to an employee of the gaming establishment to select a set of results and receiving an indication from the employee of the set of results. Once the set of results is selected, a standard deviation of the results is calculated in step 908. A formula for calculating a standard deviation of results is described above.

A desired standard deviation range is identified in step 910. Identifying a desired standard deviation range may comprise retrieving this information from memory. For example, a record of the game (e.g., in the game database 340, as embodied in FIG. 7A) may be retrieved based on the identifier of the game and the desired standard deviation range indicated in the record may be identified. If the record indicates a particular standard deviation rather than a range, step 910 may further comprise determining how this desired standard deviation may be satisfied. For example, the controller 205 may be programmed to determine that a desired standard deviation is satisfied if a calculated standard deviation is within a predetermined range of the desired standard deviation. For example, if the predetermined range is “50 points” the desired standard deviation range may be determined to be the desired standard deviation plus or minus “50 points”. In another example, if the process 900 is being performed by a gaming device, the one or more predetermined criteria 435 for the game may be retrieved. In yet another example, an employee of the gaming establishment may input a desired range (e.g., using a keyboard or other input device of controller 205, gaming device 210, or another gaming device, as appropriate).

In step 912 it is determined whether the standard deviation calculated in step 908 is within the desired standard deviation range identified in step 910. If the calculated standard deviation is within the desired standard deviation range (i.e., the one or more predetermined criteria associated with the game is satisfied by the set of results) it is determined that the game is not to be adjusted and the process 900 returns to step 902, where results of the game continue to be tracked. Otherwise, it is determined that the game is to be adjusted and the process 900 continues to step 914.

Step 914 (FIG. 9B) involves identifying one or more game parameters that are to be adjusted and identifying a respective new value for each of the one or more game parameters. Step 914 may also involve determining a goal of the adjustment of the game (e.g., to decrease the standard deviation by a particular or approximate number of points). Identifying the one or more game parameters that are to be adjusted and the respective new value for each may be done in a manner deemed to be likely to satisfy this goal. In one or more embodiments, identifying the one or more parameters to be adjusted may comprise selecting the one or more parameters from the available game adjustments database 340. In another embodiment, it may involve evaluating each parameter of the game as well as results of previous game plays and/or adjustments to identify the adjustment(s) most likely to accomplish the goal. In yet another embodiment, an employee of the gaming establishment may indicate the one or more game parameters and/or the respective new values for the one or more game parameters.

In step 916, the game is adjusted. That is, the identified respective new values are implemented for the corresponding identified game parameters of the game such that each game play initiated subsequent to the adjustment of the game is played in accordance with the new values.

In step 918 the adjusted game is tested to determine whether the adjustment of the game was successful. For example, after a predetermined number of results obtained while the respective new values for the game parameters identified in step 914 were in effect are achieved, the controller 205 may evaluate these results. The controller 205 may evaluate these results to determine whether they satisfy the one or more predetermined criteria of the game. This process may be very similar to that performed in steps 902, 906, 908, and 910, only this time for results obtained after the adjustment of the game.

In step 920 it is determined whether the standard deviation of the results obtained by players playing the adjusted game is within the desired standard deviation range. If it is, the process 900 returns to step 902, where results for the game continue to be tracked until a condition which triggers an evaluation of results is satisfied. If however, after testing the results of the adjusted game, it is determined that the one or more predetermined criteria of the game is still not satisfied (i.e., the standard deviation of the results for the adjusted game is outside the desired standard deviation range), the process 900 returns to step 914, where the game is further adjusted.

Note that, if (i) it is determined that the standard deviation of the results of the adjusted game are still not within the desired standard deviation range, and (ii) the game was adjusted based on anticipated changes in standard deviation due to suggested adjustments in particular values of particular game parameters, then determining that the adjustment was unsuccessful may cause other actions to be performed. For example, the controller 205 may update the anticipated change in standard deviation as stored in memory to reflect the actual standard deviation that resulted from the adjustment or may output a message to an employee of the entertainment establishment indicating the discrepancy.

Referring now to FIG. 9C, a graph 930 illustrates the results obtained before the adjustment of the game performed in step 900. The vertical axis of the graph 930 indicates a number of results for each value of the horizontal axis. The horizontal axis of the graph 930 indicates the number of points comprising each result, assuming a result of the game comprises a score. Note that the results of the game illustrated in graph 930 range from about “100 points” to about “10,000 points”.

Graph 950 illustrates the results obtained after the adjustment of the game. The vertical axis is again the number of results for each particular variable of the horizontal axis. The horizontal axis is again the number of points comprising each result. Assuming that the goal of the adjustment of the game was to reduce the standard deviation such that the standard deviation of results obtained after the adjustment would be smaller than the standard deviation of results obtained before the adjustment, it can be seen that the adjustment was successful. The results in graph 950 range from about “2000 points” to about “10,000 points”. Note further that the mean result has remained at about “6000 points” but more results have been obtained close to the mean results after the adjustment than before the adjustment. Accordingly, it is obvious from viewing the graph 930 and the graph 950 that the standard deviation has been decreased by the adjustment of the game. Note further that, although there are substantially fewer very low scores after the adjustment of the game, the number and magnitude of high scores has remained relatively unchanged. This may be desirable to an operator who wishes to compress a range of scores by increasing low scores while still allowing expert players to achieve relatively high scores.

Referring now to FIGS. 10A and 10B, depicted therein is a flowchart illustrating an exemplary process 1000 of adjusting a game in accordance with one or more embodiments of the present invention. Steps 1002-1008 are essentially analogous to steps 902-908 of process 900 and thus will not be described again herein.

In step 1010 the mean result of the set of results selected in step 1006 is calculated. Then, using the desired standard deviation determined in step 1008 and the calculated mean of results, a desired range of results is determined. For example, the desired range may be defined by a lower bound comprising the calculated mean results minus the desired standard deviation and by an upper bound comprising the calculated mean result plus the desired standard deviation. In this manner, a desired range of results may be determined without specifying a desired mean and without calculating a standard deviation of the results achieved by players.

The portion of the results being evaluated that are outside of the desired range is then determined in step 1014. For example, if the desired range had been determined to be “125 points-8750 points”, then step 1014 may comprise determining how many of the results being evaluated are less than “125 points” or greater than “8750 points”. That number may then be divided by the total number of results being evaluated and multiplied by one hundred to determine the percentage of results that are outside of the desired range.

In step 1016 it is determined whether the calculated percentage of results that are outside of the desired range is an acceptable percentage. This step may comprise, for example, comparing the calculated percentage to a predetermined percentage or predetermined range of percentages that is stored in memory. Alternatively, this step may comprise outputting an indication of the calculated percentage to an employee of the gaming establishment and querying the employee whether the calculated percentage is acceptable.

If it is determined, in step 1016, that the calculated percentage is acceptable, then process 1000 returns to step 1002 and results of the game continue to be tracked until a condition that triggers an evaluation of the results is satisfied. If, on the other hand, it is determined that the calculated percentage is not acceptable, it is determined that the game is to be adjusted and the process 1000 continues to step 1018.

In step 1018 at least one game parameter to be adjusted is identified and a new respective value for the parameter is identified. Step 1018 is substantially similar to step 914 of process 900 and need not be described in detail herein. The game is adjusted in step 1020 and the adjusted game tested in step 1022. Step 1020 is substantially similar to step 916 of process 900 and step 1022 is substantially similar to step 918 of process 900. Thus, neither step 1020 nor step 1022 need be described in detail herein. Note that testing the adjusted game comprises determining a new desired range that is based on the mean result of the results obtained under the adjusted game.

In step 1024 it is determined, based on the results of the test conducted in step 1022, whether the percentage of results outside of the new desired range is an acceptable percentage. This step is substantially similar to step 920 of process 900. If it is determined that the percentage is acceptable, then the process 1000 returns to step 1002, where results of the game continue to be tracked until a condition that triggers an evaluation of results is satisfied. If, on the other hand, it is determined that the percentage of results is not acceptable, then the process 1000 returns to step 1018, where the game is again adjusted.

Note that, in one or more embodiments, a desired range may be determined by using a predetermined number multiplied by the standard deviation to determine the lower bound and the upper bound of the desired range. For example, if the desired standard deviation is “500 points” and the predetermined number that the standard deviation is to be multiplied by is “4”, then the desired range may be defined by a lower bound of the mean result minus “2000 points” (i.e., 4×500=2000) and an upper bound of the mean result plus “2000 points”.

In one or more embodiments, before a game is adjusted in process 900 and/or process 1000, confirmation from an employee of the gaming establishment may be sought. For example, rather than allowing a device to automatically adjust a game if one or more predetermined criteria are not satisfied by a set of results of the game, a gaming establishment operator may desire to have an employee confirm that an adjustment is permissible before the adjustment is executed.

Referring now to FIG. 10C, a graph 1030 illustrates a distribution of results of a game before the game is adjusted in accordance with process 1000 and a graph 1050 illustrates a distribution of results of the game after the game is adjusted in accordance with the process 1000. Note that the results after the game is adjusted are concentrated in a narrower range and more results are within a mean result of the range.

The vertical axis of both graph 1030 and graph 1050 indicates a number of results obtained for each value of the horizontal axis. The horizontal axis of both graph 1030 and graph 1050 indicates a number of points comprising each score that is a result being evaluated. Assume that the desired range in the example illustrated in FIG. 10C is defined by a lower bound that is two standard deviations away from the mean result and an upper bound that is two standard deviations away from the mean.

Depicted in graph 1030 is (i) a magnitude of a desired standard deviation 1046; (ii) a mean result 1032, (iii) a value 1034 that is the mean result 1032 minus one desired standard deviation 1046, (iv) a value 1036 that is the mean result 1032 minus two of the desired standard deviations 1046 (i.e., the lower bound of the desired range 1048), (v) a value 1038 that is the mean result 1032 plus the desired standard deviation 1046, and (vi) a value 1040 that is the mean result 1032 plus two of the desired standard deviations 1046 (i.e., the upper bound of the desired range 1048).

The area 1042 indicates the results that are less than the lower bound 1036 of the desired range 1048. The area 1044 indicates the results that are greater than the upper bound 1040 of the desired range 1048. The total of the results indicated by area 1042 and by area 1044 is the portion of the results that are outside of the desired range 1048. Assume that this portion is not acceptable (e.g., greater than a predetermined portion associated with the game) and that the game was adjusted appropriately, with the goal of reducing the portion of results that are outside of the desired range.

Turning now to graph 1050, illustrated therein is the distribution of the results of game plays conducted after the adjustment of the game. The graph 1050 indicates (i) a mean result 1052, (ii) a magnitude of a desired standard deviation 1046 (which is of the same magnitude as the desired standard deviation of graph 1030); (iii) a value 1054 that is the mean result 1052 minus the desired standard deviation 1046, (iv) a value 1056 that is the mean result 1052 minus two of the desired standard deviations 1046 (i.e., the lower bound of the desired range 1068), (v) a value 1058 that is the mean result 1052 plus the desired standard deviation 1046, and (vi) a value 1060 that is the mean result 1052 plus two of the desired standard deviation 1046 (i.e., the upper bound of the desired range 1068).

Note that the mean result 1052 of the set of results obtained after the adjustment of the game is different than the mean result 1032 of the set of results obtained before the adjustment of the game. The mean result 1052 has shifted to the right in the graph and is slightly higher than the mean result 1032. Accordingly, since a desired range is calculated in process 1000 based on the mean result, the desired range 1068 of the graph 1050 is also slightly shifted to the right relative to the graph 1030 and the lower bound 1056 and upper bound 1060 are each respectively slightly higher than the lower bound 1036 and the upper bound 1040. For point of reference, the outline 1069 of the graph 1030 is illustrated as overlaid over the graph 1050. Note, however, that the desired range 1068 is the same width as the desired range 1048, since both are determined based on the same standard deviation 1046.

The area 1062 indicates the results that are less than the lower bound 1056 of the desired range 1068. The area 1064 indicates the results that greater than the upper bound 1060 of the desired range 1068. The total of the results that are indicated by area 1062 and area 1064 is the portion of the results that are outside of the desired range 1068. Note that the total of the areas 1062 and 1064 is obviously much smaller than the total of the areas 1042 and 1044. Accordingly, it can be seen that the adjustment of the game was probably successful.

Additional Embodiments

In one or more embodiments, a “bot” or computer program may take the place of a player in playing a game play of a game. For example, the controller 205 may simulate play of a game using one or more “bots”. These bots may be computer programs that are designed to play the game in a manner similar to that that which would be employed by a human player. The controller 205 may then determine whether the results obtained by the bots satisfy the one or more predetermined criteria associated with the game and adjust the game based on this determination. The use of the bots may be particularly beneficial in testing a game after it has been adjusted, to determine whether the adjustment was successful There are numerous advantages to this form of testing a game, including:

(i) It may be difficult or costly to attract a large number of human players to test unproven games. In contrast, bots are easy to duplicate and therefore large numbers of bots can be produced or programmed quickly and cost effectively.

(ii) Human players may take a long time to play games, meaning that months of testing may be required to test a game using the results of human players since a large number of results may be necessary to make the results statistically significant. Bots can play a game very quickly (e.g., much faster than human players) and continuously (e.g., they don't need to take time out to eat or sleep). Therefore testing of a game can be finished in a shorter period of time when bots are used.

In one or more embodiments, a game may be hosted by a device other than the controller 205. For example, the controller 205 may act as a listing service for a peer-to-peer network in which players play games against each other (e.g., Battle.net™).

In one or more embodiments, a player may play multiple games or multiple game plays simultaneously. For example, a skilled player may play two different games or game plays of trivia at the same time. In a second example, a player may play three hands of blackjack at the same time.

In one or more embodiments, the controller 205 may compare the variance or standard deviation of results for multiple different data sets and adjust a game based on this comparison.

In one or more embodiments, the controller 205 may standardize the variance or standard deviation for a plurality of different games or types of games. For example, assume the standard deviation or variance for results of a first game is “200 points” and the standard deviation or variance for results of a second game is “100 points”. The controller 205 may determine that the standard deviation or variance of the first game is too high and the standard deviation or variance of the second game is too low. The controller 205 may then adjust both games to have a standard deviation or variance of “150 points”.

In one or more embodiments, the controller 205 may standardize the standard deviation or variance of results of different players or types of players. For example, assume the results achieved by novice players have a variance or standard deviation of “100 points” (e.g., in a particular game or a plurality of games). Assume further that the results of expert players have a standard deviation or variance of “200 points” The controller 205 may adjust the game or games to increase the standard deviation or variance for novices and decrease the standard deviation or variance for experts.

In one or more embodiments, the controller 205 may attempt to ensure that the standard deviation or variance in results of a game or games does not vary over time. For example, the controller 205 may calculate the standard deviation or variance in results for a game or games during a first time frame (e.g., the month of September) and during a second time frame (e.g., during the month of October), and then compare the two. If the standard deviation or variance in October is significantly greater than or less than the standard deviation or variance in September, then the controller 205 may adjust the game or games to reverse the trend.

In one or more embodiments, the controller 205 may adjust a game such that the standard deviation or variance in results of the game is not significantly different from the standard deviation or variance in results of another game or games. For example, an operator of a gaming establishment may find it desirable to maintain the standard deviation or variance of results of all games or a set of games within a particular range of one another. The operator may further find it desirable that the standard deviation or variance in results is within a predetermined range of a desired standard deviation or variance.

In one or more embodiments (e.g., if controller 205 determines that adjustments of a game have been unsuccessful) a game may be more substantially modified. For example, one or more game parameters may be added or eliminated (e.g., the associated value set to zero) or a premise of the game may be changed.

Systems, apparatus and computer program products are provided for carrying out the embodiments described herein as well as numerous other embodiments of the present invention. Each computer program product described herein may be carried by a medium readable by a computer (e.g., a carrier wave signal, a floppy disc, a hard drive, a random access memory, etc.).

What is claimed is:

1. A method comprising:
determining whether a set of results achieved for a game satisfy one or more predetermined criteria associated with the game; and
adjusting the game if the set of results of the game do not satisfy the one or more predetermined criteria.

2. The method of claim 1, wherein each result comprising the set of results is determined based on a value of a parameter of the game, and wherein the step of adjusting comprises:
adjusting the value from a first value to a second value.

3. A method comprising:
determining a standard deviation of a first set of results achieved for a game, thereby determining an actual standard deviation of the first set of results;
determining a desired standard deviation; and
adjusting the game if the actual standard deviation of the first set of results is not within a predetermined range of the desired standard deviation.

4. The method of claim 3, wherein determining the standard deviation of the first set of results comprises:
selecting a set of results achieved for the game based on at least one predetermined rule.

5. The method of claim 4, wherein selecting comprises:
selecting a random subset of all results achieved for the game within a predetermined period of time.

6. The method of claim 4, wherein selecting comprises:
selecting a set of results achieved for the game within a predetermined period of time.

7. The method of claim 6, wherein selecting comprises:
selecting a set of results achieved for the game between a predetermined time and a current time.

8. The method of claim 4, wherein selecting comprises:
selecting a set of results achieved by a predetermined player.

9. The method of claim 4, wherein selecting comprises:
selecting a set of results obtained by players who are associated with a predetermined characteristic.

10. The method of claim 3, wherein determining a standard deviation comprises:
determining a standard deviation of a set of results achieved for a predetermined difficulty level of a game, thereby determining an actual standard deviation.

11. The method of claim 3, further comprising:
determining that a predetermined time has occurred; and
performing the method of claim 3 in response to the occurrence of the predetermined time.

12. The method of claim 3, further comprising:
determining that a predetermined number of results for the game has been achieved; and
performing the method of claim 3 in response to the determination that the predetermined number of results for the game has been achieved.

13. The method of claim 3, wherein determining a desired standard deviation comprises:
identifying a desired standard deviation stored in memory.

14. The method of claim 3, wherein determining a desired standard deviation comprises:
calculating a desired standard deviation based on at least one predetermined criterion.

15. The method of claim 3, wherein adjusting comprises:
adjusting the game such that an expected standard deviation of expected scores for the modified game is within the predetermined range of the desired standard deviation.

16. The method of claim 3, wherein each of the results is determined based at least on a plurality of values, each value corresponding to a respective one parameter of the game.

17. The method of claim 16, wherein adjusting the game comprises:
adjusting at least one of the values, thereby adjusting at least one of the parameters.

18. The method of claim 16, wherein adjusting comprises:
adjusting a number of points awarded for achieving an event within a game play of the game.

19. The method of claim 16, wherein adjusting comprises:
adjusting a number of attempts available for achieving an event within a game play of the game.

20. The method of claim 16, wherein adjusting comprises:
adjusting a speed of movement of an object within the game.

21. The method of claim 16, wherein adjusting comprises:
adjusting an artificial intelligence of an opponent within the game.

22. The method of claim 16, wherein adjusting comprises:
activating at least one bonus feature of the game.

23. The method of claim 16, wherein adjusting comprises:
adjusting a method of calculating a final score for a game play of the game.

24. The method of claim 16, wherein adjusting comprises:
adjusting a sensitivity of at least one input device utilized by a player while playing the game.

25. The method of claim 3, further comprising:
determining a standard deviation of results achieved for the game as adjusted, thereby determining an actual standard deviation for the adjusted game;
comparing the actual standard deviation for the adjusted game to the desired standard deviation; and
further adjusting the game if the actual standard deviation for the adjusted game is not within the predetermined range of the desired standard deviation.

26. The method of claim 25, further comprising:
performing simulated game plays of the game as modified, wherein the results achieved for the game as adjusted are results of the simulated game plays.

27. A method comprising:
determining a first set of scores of a game,
wherein each score of the first set of scores corresponds to a game play of the game and is determined based on a plurality of values, each value respectively corresponding to a game parameter of a plurality of game parameters defining the game;
adjusting a first standard deviation of a first subset of the first set of scores by adjusting at least one of the values corresponding to one of the game parameters,
wherein the first standard deviation is adjusted to be within a predetermined range.

28. The method of claim 27, further comprising:
determining a second standard deviation of a second subset of the first set of scores,
wherein the second subset comprises the first set of scores not including the first subset of the set of scores.

29. The method of claim 28, wherein the second subset comprises:
scores achieved for game plays of the game within a predetermined period of time.

30. The method of claim 29, wherein the predetermined period of time begins at a predetermined time before a current time and ends at the current time.

31. A method comprising:
determining a first set of scores of a game,
wherein each score of the first set of scores corresponds to a game play of the game and is determined based on a plurality of values, each value respectively corresponding to a game parameter of a plurality of game parameters defining the game;
decreasing a first standard deviation of a first subset of the first set of scores by adjusting at least one of the values corresponding to one of the game parameters,
wherein the first standard deviation is adjusted to be below a predetermined threshold.

32. A method comprising:
determining a first set of scores of a game,
wherein each score of the first set of scores corresponds to a game play of the game and is determined based on a plurality of values, each value respectively corresponding to a game parameter of a plurality of game parameters defining the game;
increasing a first standard deviation of a first subset of the first set of scores by adjusting at least one of the values corresponding to one of the game parameters,
wherein the first standard deviation is adjusted to be above a predetermined threshold.

33. A method comprising:
determining a first set of scores of a game,
wherein each score of the first set of scores corresponds to a game play of the game and is determined based on a plurality of values, each value respectively corresponding to a game parameter of a plurality of game parameters defining the game;
maintaining a first standard deviation of a first subset of the first set of scores by adjusting at least one of the values corresponding to one of the game parameters,
wherein the first standard deviation is maintained within a predetermined range.

34. A method comprising:
determining that a first predetermined condition for evaluating a standard deviation of scores achieved for a game has occurred;
selecting a first set of scores achieved for the game,
wherein each score of the first set of scores corresponds to a game play of the game and is based at least on a first plurality of values, each value of the first plurality of values corresponding to a respective game parameter of a plurality of game parameters;
calculating a first standard deviation, the first standard deviation comprising a standard deviation of the first set of scores;
retrieving a numerical range stored in memory;
determining that the calculated first standard deviation is not within the numerical range;
determining at least one adjustment of at least one value corresponding to one of the game parameters that is expected to result in a second standard deviation that is within the numerical range, the second standard deviation comprising a standard deviation of expected scores;
executing the at least one adjustment of the at least one value while maintaining the values of all remaining parameters, thereby determining a second plurality of values;
determining that a second predetermined condition for evaluating a standard deviation of scores achieved for the game has occurred
selecting a second set of scores achieved for the game,
wherein each score of the second set of scores corresponds to a game play of the game and is based at least on the second plurality of values;
calculating a third standard deviation, the third standard deviation comprising a standard deviation of the second set of scores; and
determining whether the third standard deviation is within the numerical range.

35. The method of claim 34, wherein the first set of scores comprises scores achieved by players playing the game.

36. The method of claim 34, wherein the second set of scores comprises scores achieved by a computer simulation of game plays of the game.

37. A method comprising:
determining a set of results achieved for a game;
determining a mean result of the set of results;
determining a desired standard deviation;
determining a desired range of results,
wherein a lower bound of the desired range is the mean result mines a predetermined number of the standard deviation and an upper bound of the desired range is the mean result plus a predetermined number of the standard deviation;
determining a portion of the set of results that are within the range; and
adjusting the game if the portion is greater than a predetermined portion.
